(19) United States
(12) Patent Application Publication
(10) Pub. No.: US 2026/0039123 A1
(43) Pub. Date: Feb. 5, 2026

(54) ADAPTABLE POWER ALLOCATION FOR MULTI-PORT CHARGER SYSTEMS

(71) Applicant: Silanna Asia Pte Ltd, Singapore (SG)

(72) Inventor: William E. Rader, III, Carrboro, NC (US)

(73) Assignee: Silanna Asia Pte Ltd, Singapore (SG)

(21) Appl. No.: 18/793,251

(22) Filed: Aug. 2, 2024

(51) Int. Cl. H02J 7/00

(52) U.S. Cl. CPC H02J 7/0013; H02J 7/00712

(57) ABSTRACT

A multi-port charger allocates a total allocated power to power delivery modules to provide power to respective sink devices at less than or equal to a total rated power capacity of the multi-port charger. Under predetermined conditions, a subsequent power allocation provided to a sink device is allowed to result in the total allocated power of the multi-port charger being greater than the total rated power capacity of the multi-port charger. After the total allocated power has been higher than the total rated power capacity for longer than a timeout time period, the total allocated power is reset to be less than or equal to the total rated power capacity of the multi-port charger.

### BACKGROUND

Many mobile devices, such as cell phones, laptop computers, tablet computers, and similar, are shipped from their respective manufacturer with a single charger. Such chargers typically receive AC power and produce a DC power output on a single port in accordance with the USB-PD (USB Power Delivery) industry standard. However, for convenience, some consumers may wish to have a single-device multi-port charger (or multiple-output power converter) that can supply a DC power output to more than one attached upward-facing port device (i.e., a “sink device”) at a time. For example, such consumers may desire a single multi-port charger that is operable to charge their cell phone and wireless headphones simultaneously so that they have to carry only one charger device.

However, multi-port chargers often must adhere to strict maximum power output limits (e.g., 45 W) as a function of charger spatial volume to limit a maximum temperature thereof. Therefore, even if a manufacturer includes two entirely separate charger circuits within a single package to implement a multi-port charger, as is conventionally done, each of those charger circuits must be power limited to provide only a fixed fraction of the total maximum power output limit. Thus, multi-port chargers reduce the available output to individual ports if the total allocated power for all ports is more than the multi-port charger can provide even though individual ports usually do not use the full power amount that has been allocated to them. For example, two charger circuits in a single package would be limited by the manufacturer to only provide half of a total maximum power output limit. In other words, multi-port chargers reduce the power level available to the attached device if the port or the total multi-port charger system is not rated or allowed to deliver that power level. As a result, sink devices plugged into such multi-port chargers will not charge as rapidly as compared to plugging each sink device into a discrete charger.

Additionally, existing multi-port chargers solutions that address some of the problems outlined herein conventionally do not provide substantial flexibility with regard to configurability or power-efficient modes of operation.

### SUMMARY

In some embodiments, a multi-port charger performs a method in which a total allocated power is allocated to power delivery modules of the multi-port charger for the power delivery modules to provide power to respective sink devices attached thereto at less than or equal to a total rated power capacity of the multi-port charger. A request for power is received from a sink device of the sink devices. It is determined when the request for power is for more power than is currently available. It is determined when, if the request for power were to be granted, the total allocated power of the multi-port charger would be less than the total rated power capacity of the multi-port charger times a threshold multiplier. It is determined when a temperature within the multi-port charger is less than a maximum temperature threshold value. A power allocation is provided to the sink device resulting in the total allocated power of the multi-port charger being greater than the total rated power capacity of the multi-port charger. After the total allocated power has been higher than the total rated power capacity for longer than a timeout time period, the total allocated power is reset to be less than or equal to the total rated power capacity of the multi-port charger.

In some embodiments, a multi-port charger performs a method in which a total allocated power is allocated to power delivery modules of the multi-port charger for the power delivery modules to provide power to respective sink devices attached thereto at less than or equal to a total rated power capacity of the multi-port charger. A request for power is received from a sink device of the sink devices at a first power delivery module of the power delivery modules. It is determined when the request for power is for more power than is currently available. It is determined when a monitored module power level provided to a second power delivery module has been lower than a power threshold value for at least a threshold time period, wherein the monitored module power level is less than an allocated power level for the second power delivery module. The allocated power level is reduced for the second power delivery module to the monitored module power level without advertising a reduced allocated power level to the second power delivery module. An allocated power level is increased for the first power delivery module in accordance with the request for power from the sink device. After the total allocated power has been higher than the total rated power capacity for longer than a timeout time period, the total allocated power is reset to be less than or equal to the total rated power capacity of the multi-port charger.

In some embodiments, a multi-port charger includes power delivery modules to which has been allocated a total allocated power for the power delivery modules to provide power to respective sink devices attached thereto at less than or equal to a total rated power capacity of the multi-port charger. When a sink device of the sink devices at a first power delivery module of the power delivery modules requires power, a request for power is generated. When 1) the request for power is for more power than is currently available, and 2) a monitored module power level provided to a second power delivery module has been lower than a power threshold value for at least a threshold time period, wherein the monitored module power level is less than an allocated power level for the second power delivery module, then the allocated power level for the second power delivery module is reduced to the monitored module power level without advertising a reduced allocated power level to the second power delivery module, and an allocated power level for the first power delivery module is increased in accordance with the request for power from the sink device. After the total allocated power has been higher than the total rated power capacity for longer than a timeout time period, the total allocated power is reset to be less than or equal to the total rated power capacity of the multi-port charger.

### BRIEF DESCRIPTION OF THE DRAWINGS

FIG. 1 is a simplified schematic of a prior-art multi-port charger.

FIG. 2 is a simplified schematic of a multi-port charger with adaptive power sharing, in accordance with some embodiments.

FIG. 3 is a simplified schematic of a circuit that includes a configurable integrated power delivery module of the multi-port charger shown in FIG. 2, in accordance with some embodiments.

FIG. 4A is a simplified schematic of a circuit providing select details of the configurable integrated power delivery module included in the circuit shown in FIG. 3, in accordance with some embodiments.

FIG. 4B is a simplified schematic of a circuit providing select details of the DC-to-DC power converter circuit included in the configurable integrated power delivery module shown in FIG. 4A, in accordance with some embodiments.

FIG. 5 through FIG. 20 provide simplified example processes for adaptive power-sharing using the multi-port charger shown in FIG. 2, in accordance with some embodiments.

### DETAILED DESCRIPTION

Some consumers desire a multi-port charger that is operable to charge multiple sink devices simultaneously. However, many conventional multi-port charger implementations have limited (or zero) flexibility for making power contracts with sink devices (i.e., electronic devices to be powered or charged by the charger) based upon sink power requests and actual power consumption of the sink devices with respect to the available power of the multi-port charger. Therefore, even if a manufacturer includes two entirely separate charger circuits within a single package to implement a multi-port charger, which is conventionally done, each of those charger circuits must be power limited to provide only a fraction of the total maximum power output limit. Additionally, some conventional solutions that distribute power between multiple ports do so in a fixed, non-configurable, and/or coarse manner, which limits flexibility and power efficiency as compared to the techniques disclosed herein.

Disclosed herein is an integrated power delivery module (i.e., a port controller device) that advantageously communicates with one or more other integrated power delivery modules of a multi-port charger. The integrated power deliver modules adaptively and continually control how much power is delivered to each port of the multi-port charger with high-granularity as power demands of the connected sink devices change over time based on calculated available power. The integrated power delivery modules adaptively and continually control how much power is delivered to each port of the multi-port charger in response to temperature changes, priority, battery charge levels, and other status events of the connected sink devices. Thus, the integrated power delivery modules and protocols monitor (in real time) the power being utilized by the sink devices connected to the respective ports, so it is possible to change the power amount allocated to any given port based (at least in part) on the amount of power it is using rather than based on a fixed amount of power or the amount that the sink device requested when it was initially attached to the port.

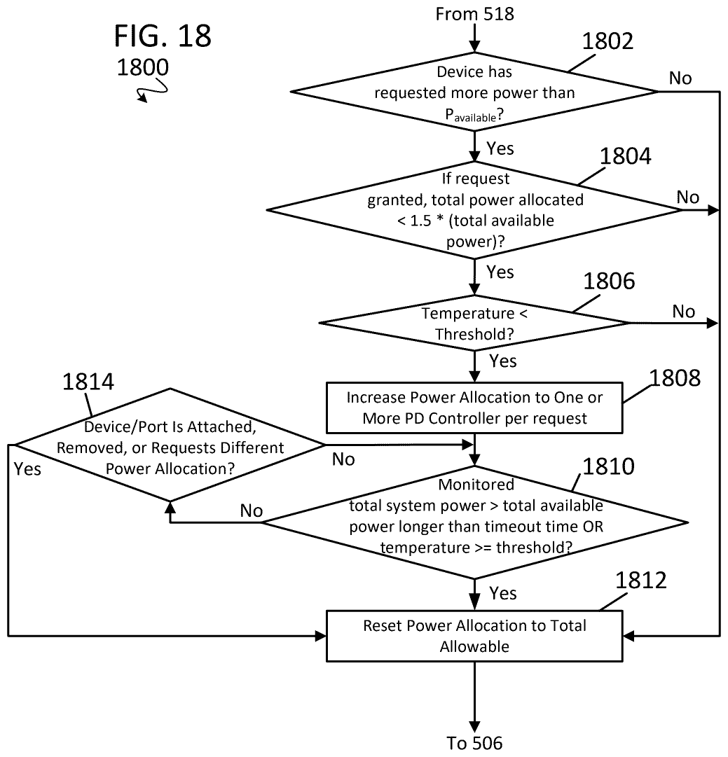

In some embodiments, as described below with respect to FIGS. 18-20, the multi-port charger is operable to temporarily increase the total power allocation to the ports or sink devices to a level above the total rated power capacity that the multi-port charger can sustainably produce when a temperature within the multi-port charger (or a part thereof) is less than a specified maximum temperature threshold value, so that some or all of the connected sink devices can receive a greater amount of power than would normally be available but for a limited time, thereby enabling greater performance or faster battery charging for the affected sink devices. Additionally or alternatively, in some embodiments, the multi-port charger is operable to temporarily increase the total power allocation to the ports or sink devices to a level above the total rated power capacity when 1) the temperature within the multi-port charger (or a part thereof) is less than the specified maximum temperature threshold value, and 2) one of the sink devices attached thereto is not using its full power allocation, so that some or all of the connected sink devices can receive a greater amount of power than would normally be available but for a limited time, thereby enabling greater performance or faster battery charging for the sink devices that receive greater power. In this case, the multi-port charger reduces the power allocation to the sink device that is not using its full power allocation but does not advertise this reduction to the sink device, so that the sink device will operate normally and can potentially return to using its full power allocation. Thus, when the power usage of the sink device increases above the lower power allocation (i.e., the power level that it had been using) for a programmable amount of time, then the multi-port charger returns the power allocation of the sink device to its previous full power allocation.

The integrated power delivery modules are named as such because a USB-PD (Universal Serial Bus Power Delivery) controller is integrated into the same package as a DC-to-DC power converter. They are operable to configure the DC-to-DC power converter therein into a low-power mode when no sink device is connected to the port associated with that integrated power delivery module. The reference to “USB”, however, is provided as only one example of the types of connectors that can potentially be used in the present disclosure for delivering power to attached sink devices. Thus, the present disclosure can be adapted to be used with other appropriate types of connectors.

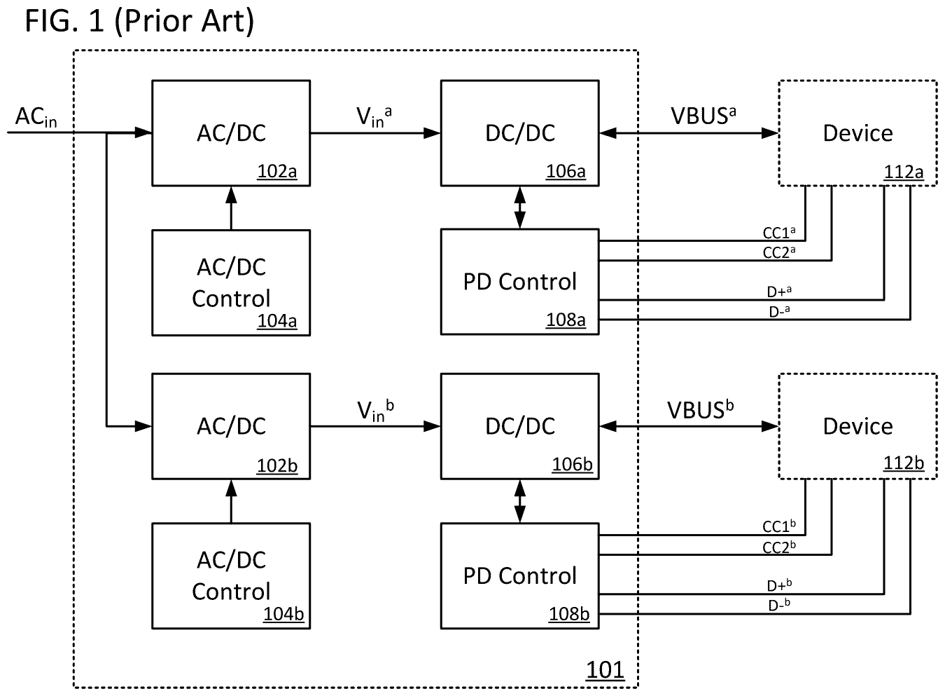

FIG. 1 is a simplified schematic of a prior-art multi-port charger 101 that is connected to sink devices 112a-b (e.g., cell phones). The multi-port charger 101 includes two independent charger circuits. A first one of the independent charger circuits of the multi-port charger 101 includes an AC-to-DC (“AC/DC”) power converter circuit 102a, an AC-to-DC power converter control circuit 104a, a DC-to-DC (“DC/DC”) power converter circuit 106a, and a USB-PD control circuit (“PD control”) 108a, connected as shown. A second one of the independent charger circuits of the multi-port charger 101 includes an AC-to-DC power converter circuit 102b, an AC-to-DC power converter control circuit 104b, a DC-to-DC power converter circuit 106b, and a USB-PD control circuit (“PD control”) 108b, connected as shown. Each of the independent charger circuits of the multi-port charger 101 receives an AC voltage ACᵢₙ and produces a respective DC voltage Vin^{a} and Vin^{b} therefrom. The DC-to-DC power converter circuits 106a and 106b respectively receive the DC voltages Vin^{a} and Vin^{b} and produce a respective USB bus voltage VBUS^{a} and VBUS^{b} therefrom. The USB-PD control circuit 108a produces signals CC1^{a}, CC2^{a}, D+^{a}, and D−^{a}, in accordance with the USB-PD standard. Similarly, the USB-PD control circuit 108b produces signals CC1^{b}, CC2^{b}, D+^{b}, and D−^{b}, in accordance with the USB-PD standard. As mentioned above, to comply with the maximum power limit of the multi-port charger 101, each of the independent charger circuits therein is conventionally power limited such that each only provides a fixed percentage of the maximum power limit.

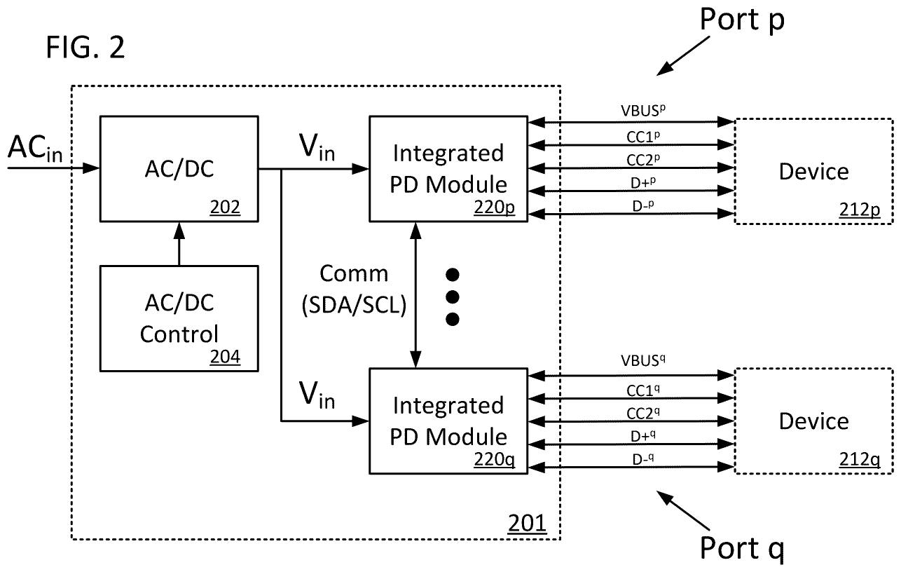

FIG. 2 is a simplified schematic of a multi-port charger 201 with configurable and adaptive power-sharing that is connected to sink devices 212p-q (e.g., cell phones), in accordance with some embodiments. The multi-port charger 201 includes a single AC-to-DC (“AC/DC”) power converter 202, a single AC-to-DC control circuit 204, and multiple integrated power delivery modules (“Integrated PD Module”, or “IPD Module”) 220p-q. Each port, p through q, of the multi-port charger 201 has a corresponding respective integrated PD module that includes a respective USB PD controller circuit, a respective module controller circuit, and a respective switch-mode DC-to-DC power converter, as described below.

The sink device 212p is electrically and communicatively coupled to port p of the multi-port charger 201 by the integrated PD module 220p. Similarly, the sink device 212q is electrically and communicatively coupled to port q of the multi-port charger 201 by the integrated PD module 220q. Some elements of the multi-port charger 201 have been omitted to simplify the description thereof but would be understood by one of ordinary skill in the art to be present.

As shown, the single AC-to-DC power converter 202 receives an AC input voltage ACᵢₙ and produces a shared DC voltage rail Vin therefrom. Each of the integrated PD modules 220p through 220q receives the DC voltage Vin and respectively produces a USB bus voltage VBUS^{p} through VBUS^{q} therefrom using an integrated switch-mode DC-to-DC power converter circuit. The integrated PD module 220p produces signals CC1^{p}, CC2^{p}, D+^{p}, and D−^{p} at port p, in accordance with the USB-PD standard. Similarly, the integrated PD module 220q produces signals CC1^{q}, CC2^{q}, D+^{q}, and D−^{q}, in accordance with the USB-PD standard. As shown by a line therebetween, the integrated PD module 220p and the integrated PD module 220q are advantageous communicatively coupled to each other via a digital communication bus “Comm (SDA/SCL)” (e.g., a serial or parallel data bus, such as a data bus that adheres to the I2C or SPI standard). Because the integrated PD module 220p and the integrated PD module 220q are communicatively coupled to each other, the integrated PD modules 220p-q are operable to communicate with one another to continually and adaptively update the amount of power delivered to each port of the multi-port charger 201 with fine control.

By comparison, some conventional distributed solutions either communicate an available amount of power using a shared analog bus having fixed resistor values or may communicate with a single power delivery coordination circuit. Such conventional solutions lack the flexibility, configurability, and granularity of control as compared to the integrated PD modules disclosed herein. For example, some conventional multi-port chargers may be operable to distribute a fixed amount of power between multiple sink devices, but may not be able to adjust how much power a first sink device is receiving based on changing device priorities and/or the status of two or more second sink devices connected to the multi-port charger.

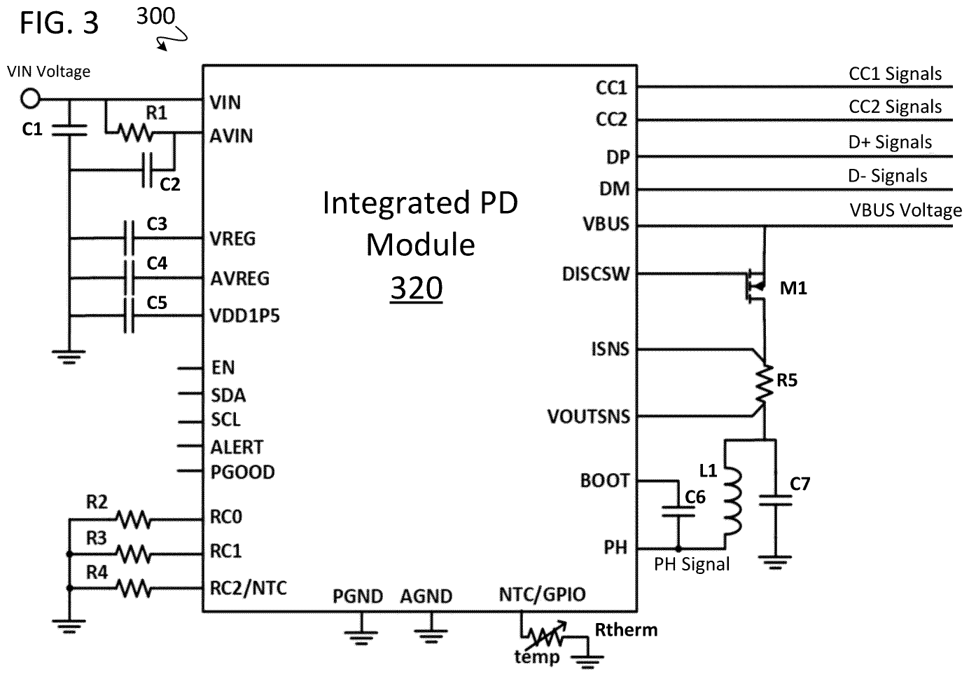

FIG. 3 is a simplified schematic of a circuit 300 that includes an integrated PD module 320 that is similar to the integrated PD modules 220p-q of the multi-port charger 201 shown in FIG. 2, in accordance with some embodiments. The circuit 300 generally includes the integrated PD module 320, resistors R1-R5, capacitors C1-C7, a switch M1, an inductor L1, and thermistor Rtherm. Also shown are signal nodes of the circuit 300, which include signal and voltage nodes designated as VIN, AVIN, VREG, AVREG, VDD1P5, EN, SDA, SCL, ALERT, PGOOD, RCO, RC1, RC2/NTC, CC1, CC2, DP, DM, VBUS, DISCSW, ISNS, VOUTSNS, BOOT, PH, PGND, AGND, and NTC/GPIO. Description of some of the nodes shown in FIG. 3 are omitted herein for brevity.

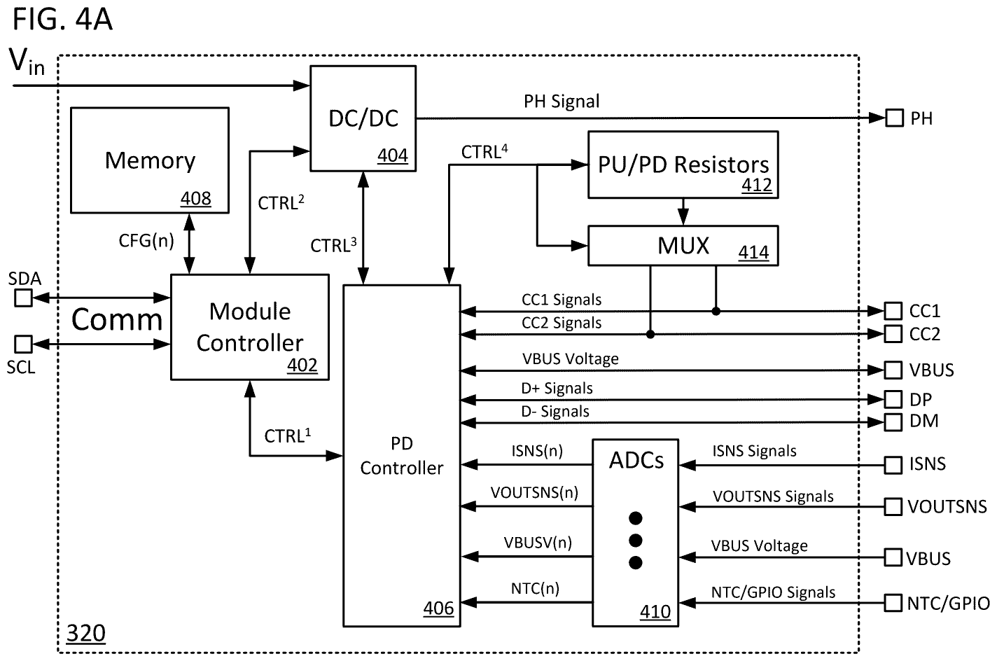

The nodes designated CC1 and CC2 are part of a configuration and communication channel for USB-PD communication with a sink device, the nodes designated DP and DM comprise a communication channel for USB-PD fast charging communication with a sink device, and the node designated VBUS of a USB voltage bus provides an output voltage to a sink device as well as serving as voltage sense line, as shown in FIG. 4A. The node designated as PH is a phase switch node for a switch-mode DC-to-DC power converter that is advantageously internal to the circuit 300 as described below. The inductor L1 and the capacitor C7 provide an output filter stage of the internal switch-mode DC-to-DC power converter.

The nodes RCO, RC1, and RC2/NTC are resistor configuration nodes used to set operational parameters of the integrated PD module 320, which are described in more detail below. The node NTC/GPIO is operable to be connected to a temperature sensing circuit (e.g., a thermistor) to provide a temperature measurement of, or near to, the integrated PD module 320.

Also shown are signals designated as CC1 Signals, CC2 Signals, D+ Signals, D− Signals, a VIN Voltage, a VBUS Voltage, and a PH Signal. Some elements and signals of the circuit 300 have been omitted to simplify the description thereof but would be understood by one of ordinary skill in the art to be present. Details of the integrated PD module 320 are described below.

FIG. 4A is a simplified schematic of a portion of the integrated power delivery module 320 shown in FIG. 3, in accordance with some embodiments. As shown, the integrated power delivery (PD) module 320 generally includes a module controller 402 (e.g., implemented using a microcontroller, a microprocessor, an FPGA, and/or an ASIC), a switch-mode DC-to-DC (“DC/DC”) power converter 404 (e.g., implemented as a switched buck-mode converter utilizing eternal components L1 and C7), a USB-PD Controller (“PD controller”) 406 to provide an adjustable DC output voltage, one or more volatile and/or non-volatile memory blocks 408 which may be part of the module controller 402 and/or the PD controller 406 or may be one or more separate modules, multiple analog-to-digital (“ADC”) converter circuits 410, programmatically controlled termination (Pull-up/Pull-down) resistors (e.g. Rp) (“PU/PD Resistors”) 412, and a signal multiplexing circuit (“MUX”) 414, connected as shown. Some elements of the integrated PD module 320 have been omitted to simplify the description thereof but would be understood by one of ordinary skill in the art to be present. Also shown are control signals CTRL¹⁻⁴, a configuration signal CFG(n), the previously introduced USB protocol signals designated as CC1 Signals, CC2 Signals, VBUS Voltage, D+ Signals, D− Signals, analog current sense ISNS signals, analog voltage sense VOUTSNS signals, an analog USB bus voltage sense signal VBUS Voltage, analog temperature measurement sense NTC/GPIO Signals, a digital representation of the analog current sense signal ISNS(n), a digital representation of the analog voltage sense signal VOUTSNS(n), a digital representation of the USB bus voltage VBUSV(n), a digital representation of an analog temperature measurement signal NTC(n), the phase node signal PH from the DC-to-DC power converter circuit 404, and communication signals SDA/SCL of a digital communication bus designated as Comm. Also shown are previously introduced nodes SDA, SCL, PH, VBUS, CC1, CC2, DP, DM, ISNS, VOUTSNS, and NTC/GPIO.

The memory block 408 is advantageously operable to store programmable (e.g., from an external interface, not shown) configurations of the integrated PD module 320, such as a maximum or total allowable power that can be delivered by the integrated PD module 320. The module controller 402 is operable to retrieve the programmable configurations from the memory block 408 via the configuration signal CFG (n) and to control the PD controller 406 and the DC-to-DC power converter circuit 404 in accordance with the retrieved programmable configurations. The module controller 402 is also operable to communicate with respective module controllers of other integrated power delivery modules of a multi-port charger, e.g., using communication signals SDA/SCL over the digital communication bus Comm, to continually and adaptively control how much power may be provided to a connected sink device by each integrated PD module 320. The module controller 402 advantageously enables each integrated PD module 320 of a multi-port charger to be configured to precisely deliver a desired amount of power to a connected sink device.

The ADC circuit 410 includes multiple ADC circuits, or one or more multiplexed ADC circuits, and is operable to receive analog signals and to create digital representations thereof. As shown, the ADC circuit 410 receives an analog current sense signal ISNS, an analog output voltage sense signal VOUTSNS, an analog VBUS voltage, and an analog temperature sense signal NTC/GPIO. The ADC circuit 410 uses the aforementioned received analog signals to create respective digital representations ISNS(n), VOUTSNS(n), VBUSV(n), and NTC(n).

The PD controller 406 is operable to use the respective digital representations for making USB control and policy decisions and is further operable to transmit the respective digital representations to the module controller 402. The module controller is operable to use the digital representations of the current sense signal ISNS(n) and the digital representation of the VBUS Voltage VBUSV(n) to calculate (e.g., by multiplying the values thereof) an actual amount of power that is being provided by the DC-to-DC power converter 404 to a sink device. Each PD controller 406 advantageously receives digital signals ISNS(s) and VBUSV(n) which are representative of sensed current and voltage, respectively, to manage power delivery to the sink device by controlling the DC-to-DC power converter 404 and/or the power contract (i.e., power allocation) established with the sink device.

The PD controller 406 includes modules (not shown) that implement the USB Power Delivery (PD) protocol to exchange commands and messages to negotiate and establish power contracts between each integrated PD module 320 and a sink device connected thereto, such as a mobile phone or notebook. The PD controller 406 communicates with the module controller 402 to advantageously coordinate and negotiate power distribution between other respective PD controllers 406. As shown in FIG. 4A, each PD controller 406 is operable to communicate with a sink device via the CC1, CC2, DP, and DM nodes.

Some sink devices require constant current and some sink devices require constant voltage. How much voltage and current is needed by a particular connected sink device is communicated by the PD controller 406 to the module controller 402, and the module controller 402 determines if the multi-port charger has enough available power remaining to deliver for that request. The module controller 402 communicates (e.g., periodically such as every 5 second, 10 seconds, 20 seconds, or another appropriate amount of time, or in response to an event) with module controllers of the other integrated PD controllers to determine the current status of total power already delivered and to calculate how much additional charger power remains available. The module controller 402 is further operable to continuously and optimally re-distribute power contracts to already connected sink devices of the multi-port charger based on changing priorities or status events of the connected sink devices. The module controller 402 and the PD controller 406 thereby advantageously manage power sharing and power allocation and power re-balancing for a multi-port charger to ensure that the total power delivered to all ports will not exceed the total power capacity of the multi-port charger.

The PD controller 406 is operable to generate an output voltage setpoint of the DC-to-DC power converter 404, using the control signal CTRL³, such that the power provided to a sink device connected to the integrated PD module 320 is advantageously only slightly above, within some margin, to what the sink device requires, thereby increasing energy efficiency as compared to conventional solutions.

The PD controller 406 and module controller 402 of each of the integrated PD modules 320 are advantageously aware of all port statuses of the multi-port charger 201. Therefore, in some embodiments, the PD controller 406 and/or the module controller 402 are aware if no ports of the multi-port charger 201 are connected to sink devices and are operable to place each DC-to-DC power converter into a low-power standby mode.

In some embodiments, the module controller 402 manages power balancing to each port of the multi-port charger 201 in granular steps, such as 2 W per 10 seconds, and power balancing is advantageously performed without the need for port resets and/or re-established handshakes.

The module controller 402 also advantageously communicates to the DC-to-DC power converter 404 via control signal CTRL² when one or more sink devices of the multi-port charger are not USB-PD compliant but is instead a normal battery charger load. In such instances, the DC-to-DC power converter 404 is set by the module controller 402 to a fixed power initially and then updated periodically. For example, the DC-to-DC power converter 404 may increase the power delivered to a load by 2 W every 10 seconds if power is still available.

The PD controller 406 and/or the module controller 402 are advantageously operable to use the digital representations ISNS (n) and VBUSV (n) to continually and adaptively determine (e.g., by multiplying the values thereof) and control an actual amount power that is delivered by the integrated PD module 320 by communicating with other integrated power delivery modules of a multi-port charger circuit. By comparison, some conventional solutions may use a shared analog power line to determine how much power is being delivered by the combined conventional power delivery modules. As disclosed herein, by calculating, using the module controller 402, how much power is being delivered by a respective integrated PD module 320, the module controller has greater flexibility in being able to change operating modes based on user configurations and preferences. For example, based on which type of sink device is connected to a particular integrated PD module 320, the module controller 420 thereof may adaptively control maximum and minimum power delivery settings.

FIG. 4B is a simplified schematic of a circuit providing select details of the DC-to-DC power converter circuit 404 included in the circuit shown in FIG. 4A, in accordance with some embodiments. As shown, the DC-to-DC power converter circuit 404 includes a buck converter controller 422, a ramp-generator circuit 424, an on-time generator circuit 426, a signal summation circuit 428, a reference voltage generator circuit 430, a high-side (“HS”) gate driver circuit 440 for a high-side switch MH, a low-side (“LS”) gate driver circuit 442 for a low-side switch ML, a low-side FET current sense circuit 444, and a fault management circuit 446, connected as shown. Also shown are the previously introduced nodes RCO, VIN, PH, PGND, and VOUT, as well as signals CTRL³, OC, PH Signal, VREF, VIN, VOUT, and “fsw, tₛₛ Select”.

The reference voltage generator 430 is operable to receive the control signal CTR³ from the PD controller circuit 406 shown in FIG. 4A to generate a reference voltage level VREF for configuring a desired VBUS output voltage based on a negotiated amount of power, voltage, and/or current to be delivered to a sink device connected thereto. The PD controller is additionally operable to adjust the reference voltage level VREF in response to the digital representation ISNS(s) of a sensed output current generated by the DC-to-DC power converter circuit 404, the digital representation VOUTSNS(n) of a sensed output voltage generated by the DC-to-DC power converter circuit 404, and/or the digital representation VBUSV(n) of a sensed USB bus voltage generated by the DC-to-DC power converter circuit 404. The fault management circuit is operable to receive an overcurrent alert signal OC, the digital representation of the output voltage VOUTSNS(n), as well as other signals, such as an indication that the input voltage is undervoltage (not shown) to halt or adjust the operation of the DC-to-DC power converter 404.

The buck converter controller circuit 422 is operable to receive the control signal CTR² from the module controller 402 and/or the control signal CTRL³ from the PD controller circuit 406 shown in FIG. 4A to change operating parameters and other configuration settings. For example, if the PD controller 406 determines that no sink device is connected to the integrated PD module 320, the DC-to-DC power converter circuit 404 may be placed in a low-power mode. In low-power mode, some or all switching signals of the DC-to-DC power converter 404 (e.g., of the ramp-generator circuit 424, and of the switches MH and ML) may be disabled to conserve power. Additionally, the buck converter controller circuit 422 is operable to receive configuration settings from node RCO that include a maximum switching frequency fs, and soft start time tss, as well as configuration settings from the module controller 402 and/or the PD controller 406.

As compared to conventional solutions, the DC-to-DC power converter 404 is configurable on a per-port basis of a multi-port converter and the configuration settings may be updated on an ongoing basis as operational conditions change.

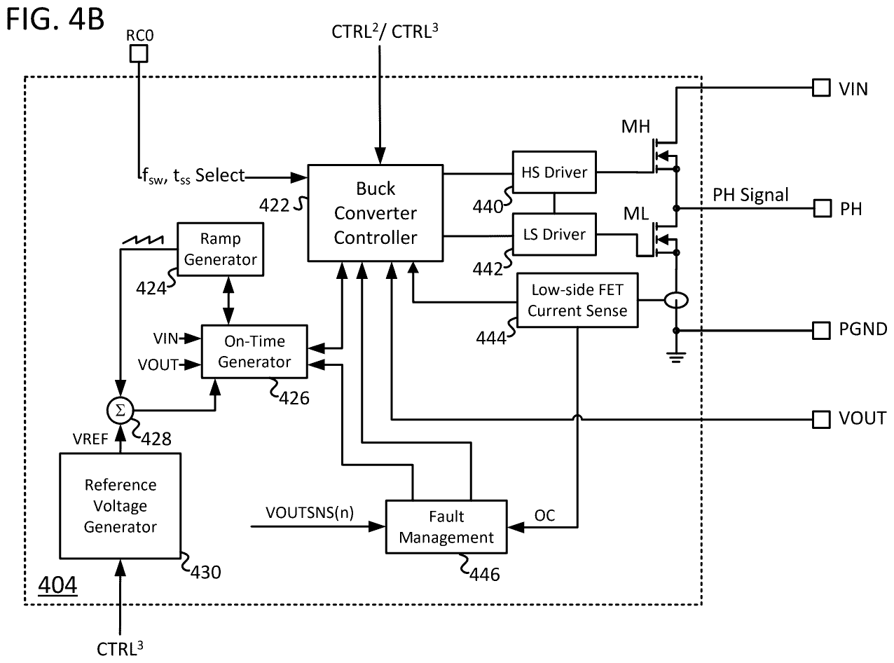

FIG. 5 provides a portion of a simplified example process 500 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

At step 501, a maximum current for each port (i.e., p through q) of the multi-port charger 201 is set by the integrated PD modules 220p-q to be 1.5 A if a Type-C standard is used for those ports. In some embodiments, one of the integrated PD modules 220p-q acts as a master controller, and each of the remaining integrated PD modules 220p-q acts as a respective slave controller. Thus, in such embodiments, the master integrated PD module commands the slave integrated PD modules to perform each of the steps described herein. By comparison, some conventional multi-port chargers rely on a single policy controller circuit that provides power delivery settings to each power delivery module thereof.

At step 502, a maximum available power P_{available} that remains to be distributed to all ports of the multi-port charger 201 (i.e., a currently available unused portion of the total power capacity of the multi-port charger) is set to a total allowable power Pₜₒₜₐₗ for the multi-port charger 201 (e.g., as specified by programmable configurations stored at the memory block 408 shown in FIG. 4A). For example, if the maximum available power P_{available} is equal to 15 W, 15 W may be distributed between the integrated PD modules 220p-q of the multi-port charger 201. In some embodiments, such distribution may be based on a fixed or changing priority of the ports and/or the connected sink devices. The priority may advantageously be configured at the time of manufacturing (e.g., based on a configuration resistor), may be programmatically configured during operation of the multi-port charger 201 (e.g., a programmed configuration setting may assign a particular port a greater priority), or may be based on a device identifier of a connected sink device (e.g., a user may configure the multi-port charger such that their phone always has a higher priority for charging as compared to a priority assigned to charging wireless headphones). Additionally, port priority may be updated automatically during the operation of the multi-port charger based on the status of connected sink devices as well as other factors, such as changing battery charge levels of respective batteries of the sink devices, port temperatures, a powered status of the connected sink devices (e.g., a sink device that is powered on may receive a higher power allocation as compared to a sink device that is off and is merely being recharged), or other status.

For example, port p may be allocated a power output of p_{alloc}^{p}=15 W, and port q may be allocated a power output of p_{alloc}^{q}=0 W. Or, port p may be allocated a power output of p_{alloc}^{p}=10 W, and port q may be allocated a power output of p_{alloc}^{q}=5 W. Or, port p may be allocated a power output of p_{alloc}^{p}=7.5 W, and port q may be allocated a power output of p_{alloc}^{q}=7.5 W, and so on. This adaptive allocation occurs continually (e.g., every 5 s, 10 s, 15 s, or at another appropriate update rate) as the power requirements, status, and/or states of sink devices connected to the multi-port charger 201 change. For example, if two sink devices having completely drained batteries are connected to the multi-port charger 201, a first sink device connected to the master integrated PD module will initially receive a maximum allocated power and a second sink device connected to a slave integrated PD module will initially receive a minimum allocated power. As the first sink device charges, the power required by that sink device will decrease. As the power required by the first sink device decreases, the integrated PD modules of the multi-port charger 201 adaptively increase the power delivered to the second sink device and decrease the power delivered to the first sink device. In some embodiments, P_{available} is stored at a master integrated PD module of the multi-port charger 201. In other embodiments, P_{available} is stored at each integrated PD module of the multi-port charger 201.

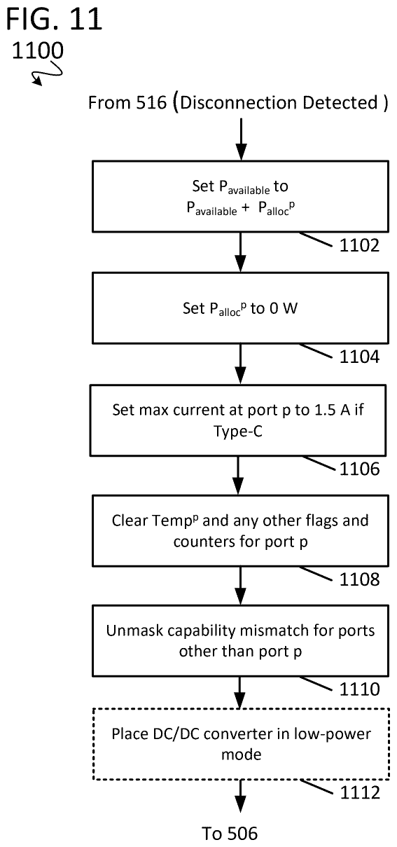

At step 503, the total power allocated to each port p-q of the multi-port charger 201 is initialized to 0 W. At step 504, USB event detection is enabled at each port p-q of the multi-port charger 201. At step 506, each integrated PD module of the multi-port charger 201 waits for event detection at the port that corresponds to that integrated PD module. Flow may continue to step 508 or step 1202 (shown in FIG. 12) based on which event was determined to have occurred. The series of steps 508 through 516 may be performed in series or in parallel with the series of steps 1202 through 1214 shown in FIG. 12.

Upon detecting a USB event at one or more ports at step 506, the steps that follow are described with reference to USB events detected specifically at port p of the multi-port charger 201 using the integrated PD module 220p for simplicity. However, similar, or the same steps are followed for USB events detected at any of the other ports p-q of the multi-port charger 201.

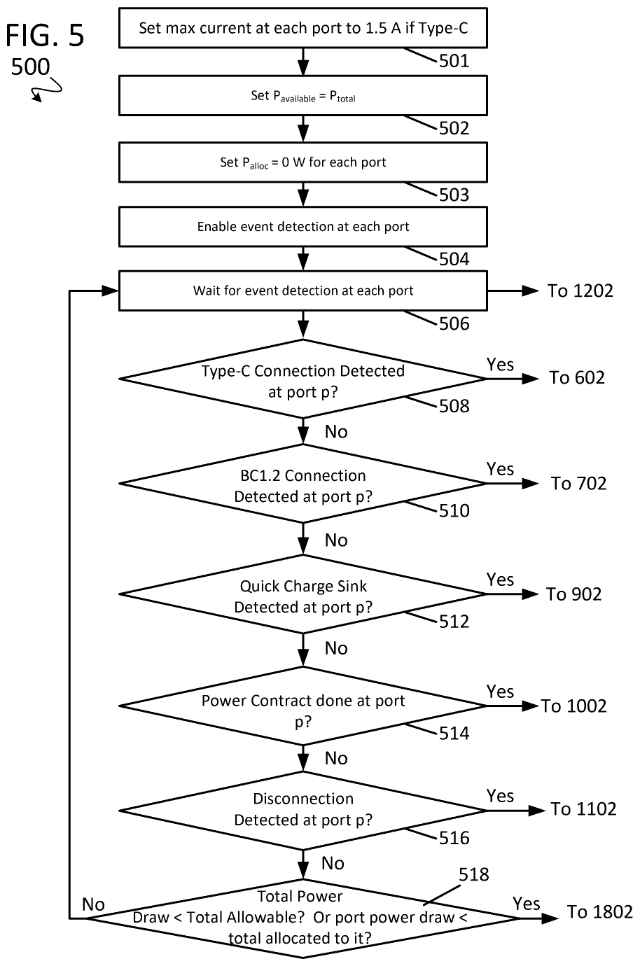

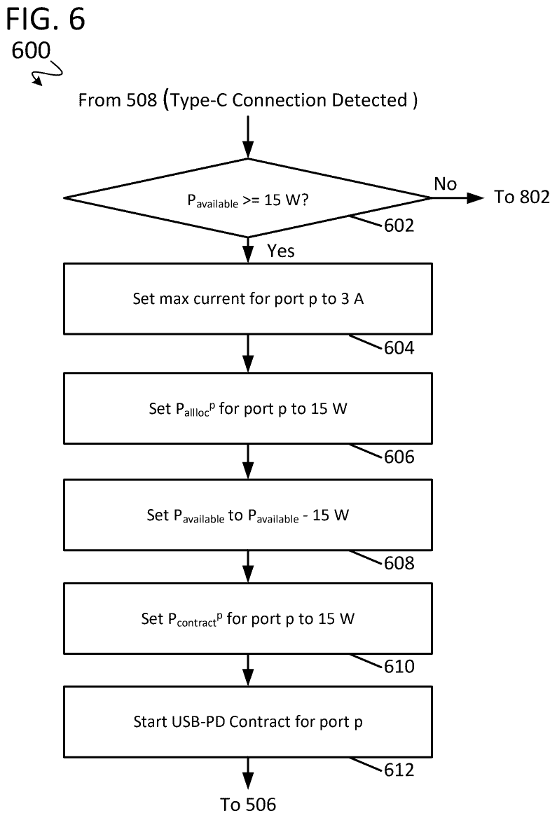

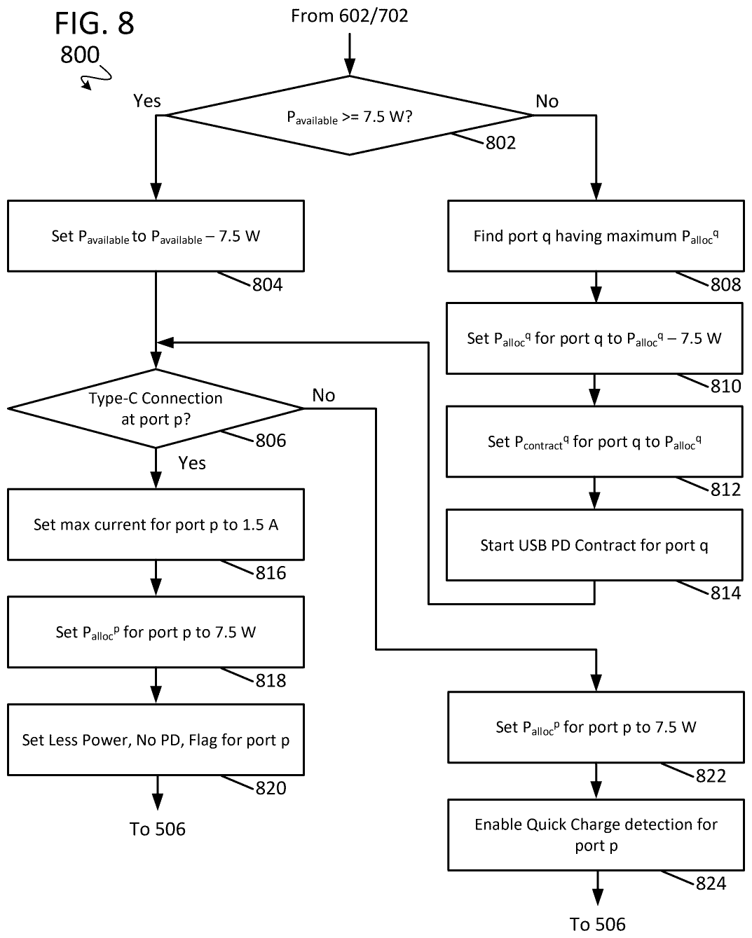

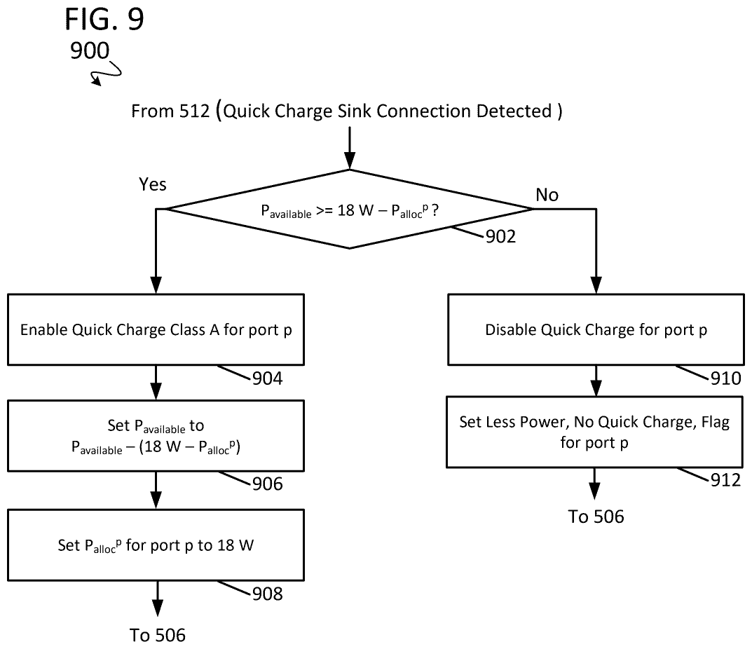

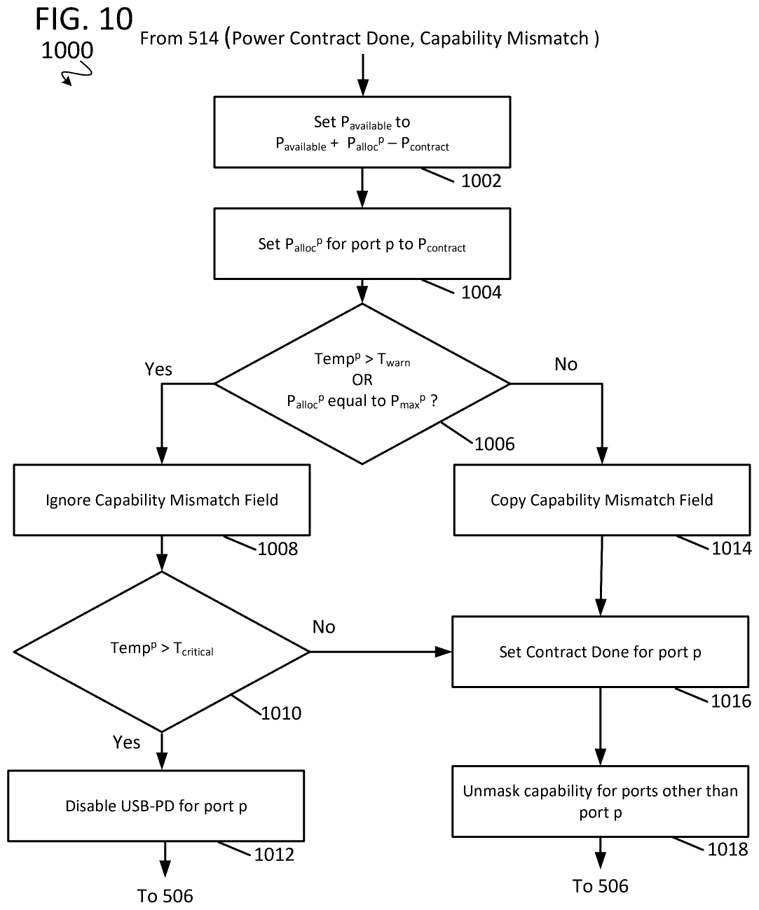

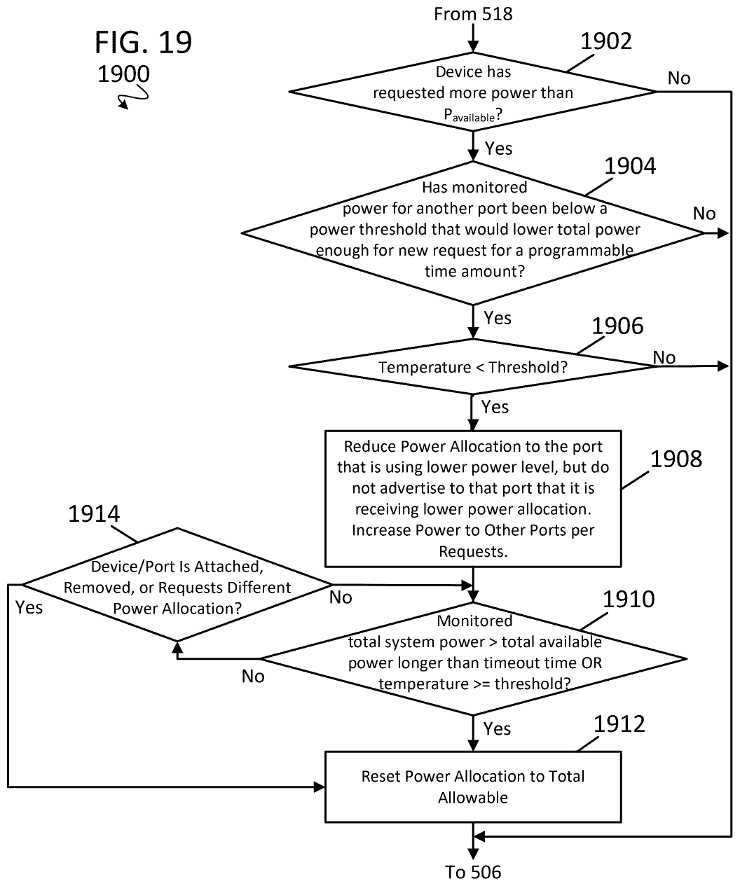

At step 508, if a Type-C connection was detected at port p, flow of the process 500 continues to step 602 shown in FIG. 6. Otherwise, flow continues to step 510. At step 510, if a USB Standard BC1.2 (USB Battery Charging version 1.2) connection was detected at port p, flow of the process continues to step 702 shown in FIG. 7. Otherwise, flow continues to step 512. At step 512, if a quick charge sink connection was detected at port p, flow of the process continues to step 902 shown in FIG. 9. Otherwise, flow continues to step 514. At step 514, if power contract negotiation is complete, in accordance with the USB-PD standard, flow continues to step 1002 shown in FIG. 10. Otherwise, flow continues to step 516. At step 516, if a sink device disconnection was detected at port p, flow continues to step 1102 shown in FIG. 11. At step 518, if the multi-port charger 201 detects or determines that the total power draw of all of the sink devices attached thereto is less than the total power that the multi-port charger 201 can potentially produce, or if the multi-port charger 201 detects that one of the sink devices attached thereto is drawing less than the total power allocated to that sink device, then flow continues to step 1802 or 1902 shown in FIG. 18 or 19, respectively. Otherwise, flow returns to step 506. Alternatively, at step 518, the multi-port charger 201 simply determines that a power request has been received, regardless of the total power draw, total power allocated to any one sink device, or maximum thermal power level. In this case, the power request is granted and the flow continues to step 1802 or 1902 to then monitor the power levels afterwards, so that if the power request results in the total allocated power being above the total power capacity that the multi-port charger can sustainably deliver without exceeding device ratings or temperature requirements for more than a set amount of time, then either process 1800 or 1900 will eventually reduce the total allocated power. In another alternative, at step 518, the multi-port charger 201 simply determines that a sink device has begun using more power than it has been allocated. In this case, the multi-port charger 201 increases the power allocated to that sink device without advertising the increase to the sink device even if the increase pushes the total allocated power higher than the maximum thermal power level for the multi-port charger 201 or the integrated PD module for that sink device. Then the flow continues to step 1802 or 1902 to then monitor the power levels afterwards, so that if the power increase results in the total allocated power being above the total power capacity that the multi-port charger can sustainably deliver without exceeding device ratings or temperature requirements for more than a set amount of time, then either process 1800 or 1900 will eventually reduce the total allocated power.

FIG. 6 provides a portion of a simplified example process 600 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

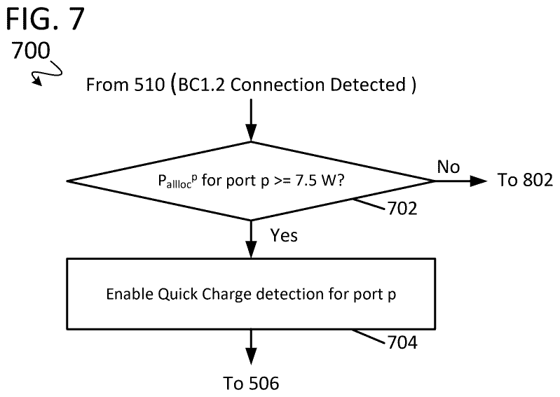

Step 602 of the process 600 continues from step 508 shown in FIG. 5 and is performed in response to a determination at step 508 that a Type-C connection was detected at port p. At step 602, if it is determined by negotiating between the module controllers 402 of the integrated PD modules 220p-q of the multi-port charger 201 using the digital communication bus Comm that the maximum available power P_{available} that remains to be distributed between the ports of the multi-port charger 201 is greater than or equal to a target amount of power (e.g., 15 W), flow continues to step 604. Otherwise, flow continues to step 802 shown in FIG. 8.

At step 604, a maximum current for port p is set to 3 A by configuring the programmatically controlled termination resistors 412 and signal multiplexing circuit 414, using the PD controller 406 via the control signal CTRL⁴, to values indicative of Rp 3.0 (e.g., about 10 k Ohms), per the USB-PD standard, and updating a setting of the DC-to-DC power converter 404 if needed). At step 606, the target allocated power P_{alloc}^{p} for port p is set to 15 W. As such, port p of the multi-port charger 201 will deliver up to, but no more than, 15 W of power to a sink device connected to port p of the multi-port charger 201 and a setting of the DC-to-DC power converter 404 is updated accordingly if needed. At step 608, because 15 W of power has been allocated to port p, the maximum available power P_{available} of the multi-port charger 201 that remains to be distributed between the ports thereof is reduced by 15 W. The adjustment in maximum available power P_{available} is communicated to one or more other integrated PD modules 220p-q by the module controller 402 via the digital communication bus Comm. At step 610, the USB-PD contract P_{contract}^{p} for port p is set to 15 W, in accordance with the USB-PD standard. At step 612, USB-PD contract negotiation for port p is initiated by the integrated PD module in accordance with the USB-PD standard. Flow of the process then returns to step 506 shown in FIG. 5.

FIG. 7 provides a portion of a simplified example process 700 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 702 of the process 700 continues from step 510 shown in FIG. 5 and is conducted in response to a determination at step 510 that a BC1.2 connection was detected at port p. At step 702, if it is determined that the power P_{alloc}^{p} allocated to port p of the multi-port charger 201 (i.e., via communication between the integrated PD modules thereof using the digital communication bus Comm) is greater than or equal to a target amount of power (e.g., 7.5 W), flow of the process 700 continues to step 704. Otherwise, flow continues to step 802 shown in FIG. 8. At step 704, quick charge detection is enabled for port p of the multi-port charger 201. Flow of the process then continues back to step 506 shown in FIG. 5.

FIG. 8 provides a portion of a simplified example process 800 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 802 of the process 800 continues from either step 602 shown in FIG. 6, or from step 702 shown in FIG. 7. At step 802, if it is determined by negotiating between the module controllers 402 of the integrated PD modules 220p-q of the multi-port charger 201 using the digital communication bus Comm that the maximum available power P_{available} of the multi-port charger 201 that remains to be distributed between the integrated PD modules thereof is greater than or equal to a target amount of power (e.g., 7.5 W), flow of the process 800 continues to step 804. At step 804, the maximum available power P_{available} of the multi-port charger 201 that remains to be distributed to ports thereof is reduced by 7.5 W. The adjustment in maximum available power P_{available} is communicated to one or more other integrated PD modules 220p-q by the module controller 402 via the digital communication bus Comm. At step 806, if it is determined that a USB Type-C connection was detected at port p, flow continues to step 816. At step 816, a maximum current for port p is programmatically set to 1.5 A by configuring the programmatically controlled termination resistors 412 and signal multiplexing circuit 414, using the PD controller 406 via the control signal CTRL⁴, to values indicative of Rp 1.5 (e.g., about 22 k Ohms), per the USB-PD standard. Conventional solutions may use fixed resistor termination resistor values, designated in the USB standard as Rp, which determine a maximum current-carrying capability of a power source. As disclosed herein, the PD controller 406 is operable to adaptively adjust, by controlling the DC-to-DC power converter, how much current can be provided to a sink device by the integrated PD module.

At step 818, the target allocated power P_{alloc}^{p} for port p is set to 7.5 W. At step 820, several flags are set by the PD controller 406 for port p, including a Less Power Flag and a No PD Flag, in accordance with the USB-PD standard. These flags are asserted when the power requested by a sink device cannot be supplied by the port associated with that sink device (e.g., not enough power has been allocated to that port). The asserted flags indicate to the multi-port charger 201 that more power should be supplied to the sink device as more power becomes available. Flow then returns to step 506 shown in FIG. 5.

If it was determined at step 802 that P_{available} is not greater than or equal to (i.e., is less than) 7.5 W, flow of the process 800 continues to step 808 to advantageously reduce power allocated to another port of the multi-port charger 201. At step 808, the integrated PD modules of the multi-port charger 201 communicate between themselves using module controllers 402 thereof via the digital communication bus Comm to identify a port of the multi-port charger 201, (e.g., port q), that currently has the maximum allocated power, e.g., P_{alloc}^{q}. That is, in this example, port q has the current maximum allocated power. At step 810, the allocated power P_{alloc}^{q} for port q is reduced by 7.5 W. At step 812, the USB-PD contract P_{contract}^{q} for port q is set to P_{alloc}^{q}. At step 814, USB-PD contract negotiation for port q is initiated by the integrated PD module associated with port q (e.g., the integrated PD module 220q), in accordance with the USB-PD standard. Flow of the process 800 then continues to step 806 which was described above.

If it was determined at step 806 that the connection at port p is not USB Type-C, flow continues to step 822. At step 822, the allocated power P_{alloc}^{p} for port p is set to 7.5 W. At step 824, quick charge detection is enabled for port p. Flow then returns to step 506 shown in FIG. 5.

FIG. 9 provides a portion of a simplified example process 900 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 902 of the process 900 continues from step 512 shown in FIG. 5 and is conducted in response to a determination at step 512 that a USB quick charge sink device connection was detected at port p. If it is determined by negotiating between the module controllers 402 of the integrated PD modules 220p-q of the multi-port charger 201 using the digital communication bus Comm that the maximum available power P_{available} of the multi-port charger 201 that remains to be distributed between the ports thereof is greater than or equal to a target amount of power (e.g., 18 W) minus the power P_{alloc}^{p} currently allocated to port p, flow of the process 900 continues to step 904. At step 904, USB quick charge class A mode is enabled for port p, in accordance with the USB-PD standard. At step 906, the maximum available power P_{available} of the multi-port charger 201 that remains to be distributed between the ports thereof is reduced by 18 W and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 908, the target amount of power P_{alloc}^{p} allocated to port p is updated to 18 W. Flow then returns to step 506 shown in FIG. 5.

If it was determined at step 902 that the maximum available power P_{available} of the multi-port charger 201 that remains to be distributed to ports thereof is not greater than or equal to (i.e., is less than) 18 W minus the power P_{alloc}^{p} currently allocated to port p, flow of the process 900 continues to step 910. At step 910, USB quick charge mode is disabled for port p, in accordance with the USB-PD standard. Additionally, at step 912, several flags are set for port p, including a Set Less Power and No Quick Charge, in accordance with the USB-PD standard. Flow then returns to step 506 shown in FIG. 5.

FIG. 10 provides a portion of a simplified example process 1000 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 1002 of the process 1000 continues from step 514 shown in FIG. 5 and is conducted in response to a determination at step 514 that completion of a USB power contract negotiation, in accordance with the USB-PD standard, was detected at port p. Additionally, USB capability mismatch for the sink device at port p may have occurred. USB capability mismatch occurs when a sink device cannot satisfy its power requirements from the capabilities offered by the source (i.e., the power delivered by port p). At step 1002, the maximum available power P_{available} of the multi-port charger 201 that remains to be distributed between the ports thereof is reduced by the negotiated power P_{contract}, and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 1004, the amount of power P_{alloc}^{p} allocated to port p is updated to P_{contract}.

At step 1006, if it is determined if a counter Temp^{P} of excess temperature events for port p has exceeded a first excess temperature event count threshold T_{warn}, or that the power P_{alloc}^{p} allocated to port p is already equal to a maximum amount of power Pₘₐₓ^{p} that the integrated PD module at port p is able to deliver, flow of the process continues to step 1008. USB temperature event detection is described in more detail below with reference to FIG. 1200.

At step 1008, because the counter Temp^{p} of excess temperature events was greater than the first excess temperature event count threshold T_{warn}, the USB Capability Mismatch flag for the sink device at port p is ignored by the integrated PD module associated with port p. Flow continues to step 1010, where it is determined if the counter Temp^{p} of excess temperature events is greater than a second excess temperature event count threshold T_{critical}. If the counter Temp^{p} of excess temperature events is greater than a second excess temperature event count threshold T_{critical}, at step 1012, USB-PD is disabled for port p. Flow then returns to step 506 shown in FIG. 5.

If it was determined at step 1006 that the counter Temp^{p} of excess temperature events for port p had not exceeded the first excess temperature event count threshold T_{warn}, and that the power P_{alloc}^{p} allocated to port p was not already equal to the maximum amount of power Pₘₐₓ^{p} that the integrated PD module at port p is able to deliver, flow of the process continues to step 1014. At step 1014, the USB capability mismatch field is copied by the associated integrated PD module (i.e., it is not ignored by the integrated PD module associated with port p). At step 1016, a flag indicating that the PD contract negotiation at port p is complete is set at the associated integrated PD module. Flow additionally continues to step 1016 from step 1010, described above, if it was determined at step 1010 that the counter Temp^{p} of excess temperature events is not greater than a second excess temperature event count threshold T_{critical}. At step 1018, capabilities for ports of the multi-port charger 201 other than port p are unmasked by the integrated PD modules of the multi-port charger 201. Flow of the process then returns to step 506 shown in FIG. 5.

FIG. 11 provides a portion of a simplified example process 1100 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 1102 of the process 1100 continues from step 516 shown in FIG. 5 and is performed in response to a determination at step 516 that a USB sink device disconnection has been detected at port p. At step 1102, the amount of power P_{alloc}^{p} that was previously allocated to port p is added back to the maximum available power P_{available} that remains to be distributed between the ports thereof. The adjustment in maximum available power P_{available} is communicated to one or more other integrated PD modules 220p-q by the module controller 402 via the digital communication bus Comm. At step 1104, the amount of power P_{alloc}^{p} allocated to port p is updated to 0 W (because no sink device is connected at port p). At step 1106, a maximum current for port p is programmatically set to 1.5 A by configuring the programmatically controlled termination resistors 412 and signal multiplexing circuit 414, using the PD controller 406 via the control signal CTRL⁴, to values indicative of Rp 1.5 (e.g., about 22 k Ohms), per the USB-PD standard if port p is configured as USB Type-C. At step 1108, any status flags and counters that were associated with the sink device previously connected to port p, such as the counter Temp^{p} of excess temperature events, are cleared by the integrated PD module associated with port p. At step 1110, USB capability mismatch is unmasked, per the USB-PD standard, for ports other than port p.

In some embodiments, at step 1112, the integrated PD module associated with port p is advantageously operable to place the DC-to-DC power converter therein into a low-power consumption mode until a sink device is connected to port p. For example, the DC-to-DC power converter may be placed in a standby mode in which switching signals are disabled, thereby increasing an overall power efficiency of the multi-port charger 201 as compared to chargers that do enter a low-power mode. Flow of the process then returns to step 506 shown in FIG. 5.

FIG. 12 provides a portion of a simplified example process 1200 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

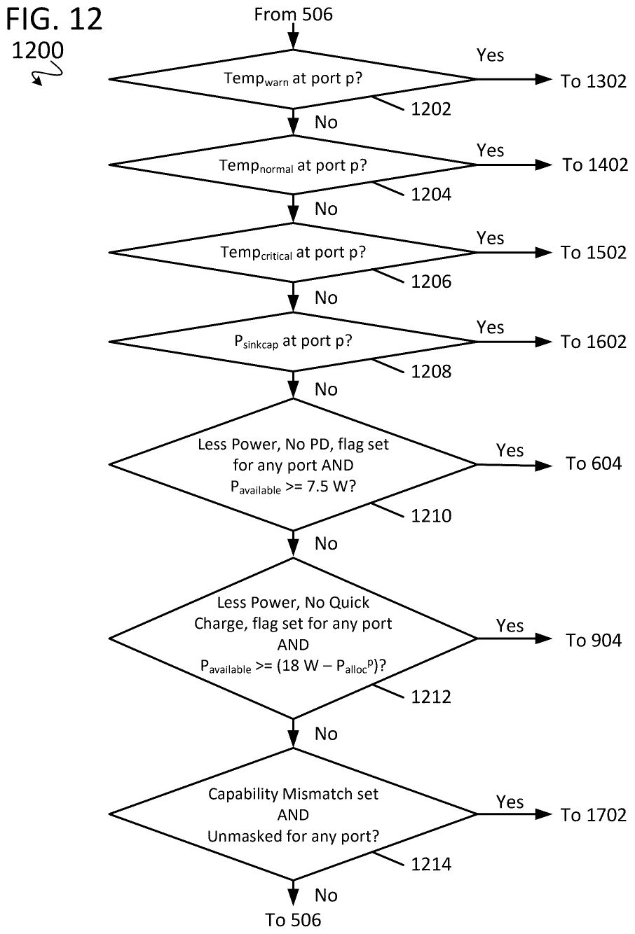

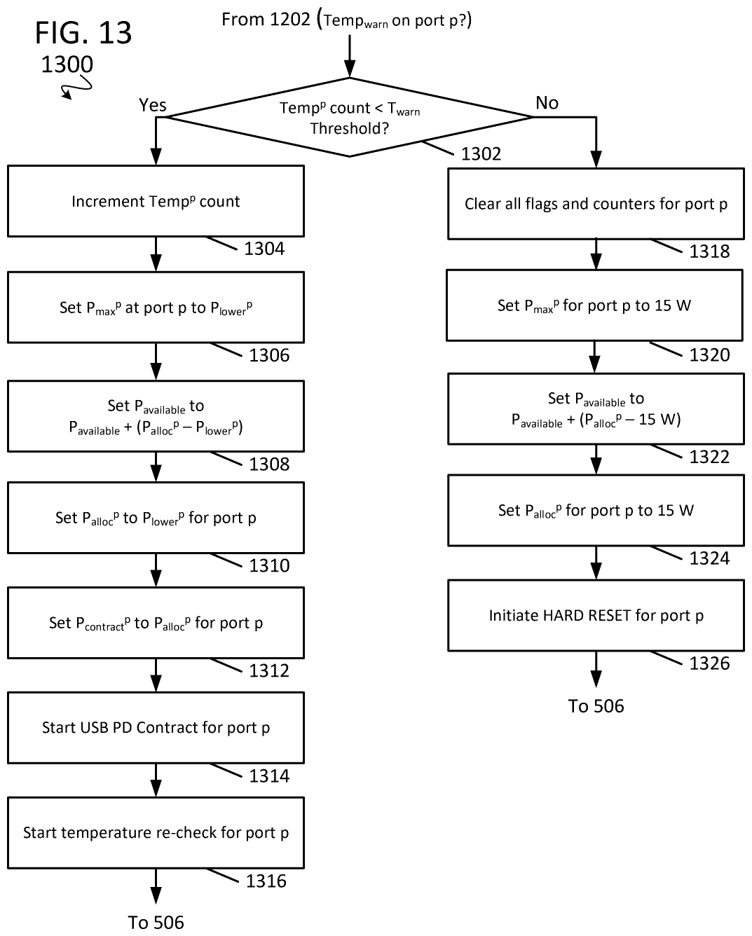

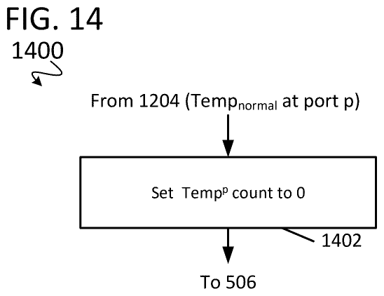

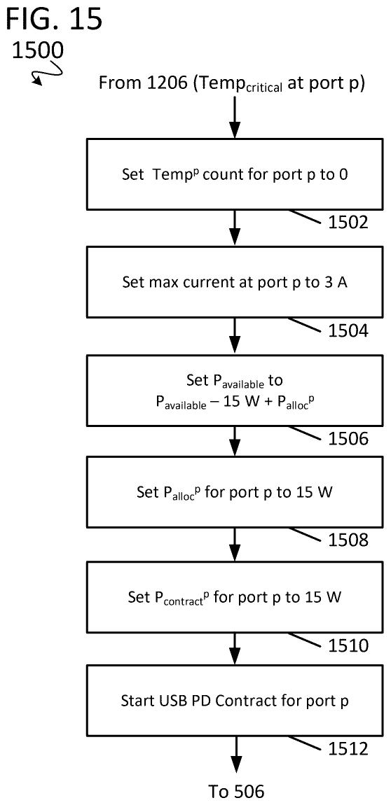

The steps of process 1200 continue from step 506 shown in FIG. 5. At step 1202, if an excess temperature warning event Temp_{warm} was detected at port p by an associated integrated PD module, flow continues to step 1302, shown in FIG. 13. Otherwise, flow continues to step 1204. At step 1204, if a normal temperature event Tempₙₒᵣₘₐₗ was detected at port p by an associated integrated PD module, flow continues to step 1402, shown in FIG. 14. Otherwise, flow continues to step 1206. At step 1206, if a critical temperature event Temp_{critical} was detected at port p by an associated integrated PD module, flow continues to step 1502, shown in FIG. 15. Otherwise, flow continues to step 1208. At step 1208, if a sink capabilities event P_{sinkcap} was detected at port p by an associated integrated PD module, flow continues to step 1602, shown in FIG. 16. Otherwise, flow continues to step 1210.

At step 1210, if it is determined, (e.g., using the controller modules thereof via the digital communication bus Comm), that a USB Less Power, No PD, flag is set for any port of the multi-port charger 201, and that the maximum available power P_{available} that remains to be distributed between the ports thereof is greater than or equal to 7.5 W, flow returns to step 604 shown in FIG. 6. Otherwise, flow continues to step 1212.

At step 1212, if it is determined, (e.g., using the controller modules thereof via the digital communication bus Comm), that a USB Less Power, No Quick Charge, flag is set for any port of the multi-port charger 201 and that the maximum available power P_{available} that remains to be distributed between the ports thereof is greater than or equal to 18 W minus the amount of power P_{alloc}^{p} allocated to port p, flow returns to step 904 of FIG. 9. Otherwise, flow continues to step 1214.

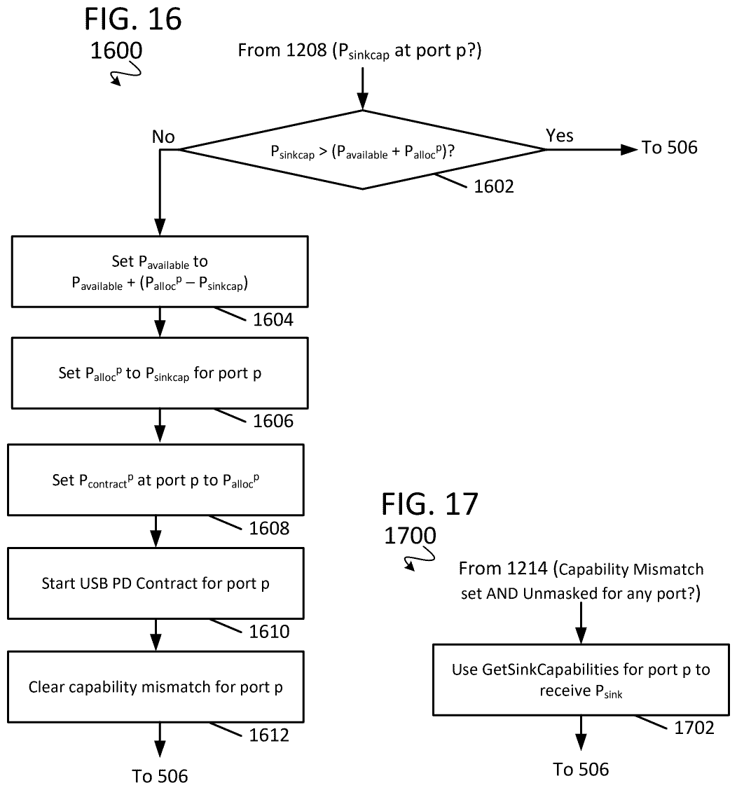

At step 1214, if it is determined, (e.g., using the controller modules thereof via the digital communication bus Comm), that a USB Capability Mismatch flag is set for port p and that capability mismatch is unmasked for any port of the multi-port charger 201, flow continues to step 1702 shown in FIG. 17. Otherwise, flow returns to step 506 shown in FIG. 5.

FIG. 13 provides a portion of a simplified example process 1300 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 1302 of the process 1300 continues from step 1202 shown in FIG. 12 and is conducted in response to a determination that an excess temperature warning event Temp_{warn} was detected at port p by an associated integrated PD module. At step 1302, if it is determined that the counter Temp^{p} of excess temperature events at port p is less than the first excess temperature event count threshold T_{warn}, flow of the process continues to step 1304. At step 1304, the counter Temp^{p} of excess temperature events at port p is incremented. At step 1306, the maximum amount of power Pₘₐₓ^{p} that the integrated PD module at port p is permitted to deliver is reduced to a lower power level P_{lower}^{p}. At step 1308, the maximum available power P_{available} of the multi-port charger 201 that remains to be distributed between ports thereof is reduced by the new lower power level P_{lower}^{p} and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 1310, the amount of power P_{alloc}^{p} allocated to port p is updated to P_{lower}^{p}. At step 1312, the USB-PD contract P_{contract}^{p} for port p is set to P_{alloc}^{p}. At step 1314, USB-PD contract negotiation for port p is initiated by the integrated PD module associated with port p, in accordance with the USB-PD standard. At step 1316, the integrated PD module associated with port p initiates a temperature re-check process for the sink device connected to port p. Flow of the process then returns to step 506 shown in FIG. 5.

If it was determined at step 1302 that the counter Temp^{p} of excess temperature events at port p is not less than (i.e., is greater than or equal to) the first excess temperature event count threshold T_{warn}, flow of the process continues to step 1318. At step 1318, all flags and counters associated with port p are cleared. At step 1320, the maximum amount of power Pₘₐₓ^{p} that the integrated PD module at port p is permitted to deliver is set to 15 W. At step 1322, the maximum available power P_{available} of the multi-port charger 201 that remains to be distributed between the ports thereof is reduced by 15 W, and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 1324, the amount of power P_{alloc}^{p} allocated to port p is updated to 15 W. At step 1326, a hard reset, in accordance with the USB-PD standard, is initiated by the integrated PD module associated with port p. Flow of the process then returns to step 506 shown in FIG. 5.

FIG. 14 provides a portion of a simplified example process 1400 for adaptive power-sharing using the multi-port charger 201 shown in FIG. 2, in accordance with some embodiments. The particular step, the order in which the step is performed, and the combination of the step with other steps disclosed herein are shown for illustrative and explanatory purposes only. Other embodiments can implement different particular steps, orders of steps, and combinations of steps to achieve similar functions or results.

Step 1402 of the process 1400 continues from step 1204 shown in FIG. 12 and is conducted in response to a determination that a normal temperature event Tempₙₒᵣₘₐₗ was detected at port p by an associated integrated PD module. Accordingly, at step 1402, the counter Temp^{p} of excess temperature events at port p is reset to 0. Flow of the process then returns to step 506 shown in FIG. 5.

FIG. 15 provides a portion of a simplified example process 1500 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 1502 of the process 1500 continues from step 1206 shown in FIG. 12 and is conducted in response to a determination that a critical excess temperature event Temp_{critical} was detected at port p by an associated integrated PD module. At step 1502, the counter Temp^{p} of excess temperature events at port p is reset to 0. At step 1504, a maximum current for port p is set to 3 A by configuring the programmatically controlled termination resistors 412 and signal multiplexing circuit 414, using the PD controller 406 via the control signal CTRL⁴, to values indicative of Rp 3.0 (e.g., about 10 k Ohms), per the USB-PD standard. At step 1506, the maximum available power P_{available} of the multi-port charger 201 that remains to be distributed between the ports thereof is reduced by 15 W and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 1508, the amount of power P_{alloc}^{p} allocated to port p is updated to 15 W. At step 1510, the USB-PD contract P_{contract}^{p} for port p is set to 15 W. At step 1512, USB-PD contract negotiation for port p is initiated by the integrated PD module associated with port p, in accordance with the USB-PD standard. Flow of the process then returns to step 506 shown in FIG. 5.

FIG. 16 provides a portion of a simplified example process 1600 for adaptive power-sharing using the multi-port charger 201 shown in FIG. 2, in accordance with some embodiments. The particular steps, the order of steps, and the combination of steps are shown for illustrative and explanatory purposes only. Other embodiments can implement different particular steps, orders of steps, and combinations of steps to achieve similar functions or results.

Step 1602 of the process 1600 continues from step 1208 shown in FIG. 12 and is conducted in response to a P_{sinkcap} power event being detected at port p by the associated integrated PD module. At step 1602, if it is determined that the P_{sinkcap} power is greater than the maximum available power P_{available} of the multi-port charger 201 that remains to be distributed between the ports, plus the amount of power P_{alloc}^{p} previously allocated to port p, flow returns to step 506 shown in FIG. 5. Otherwise, flow continues to step 1604. At step 1604, the maximum available power P_{available} of the multi-port charger 201 that remains to be distributed between the ports thereof is reduced by the P_{sinkcap} power, and the amount of power P_{alloc}^{p} previously allocated to port p is added back to the maximum available power P_{available}. The adjustment in maximum available power P_{available} is communicated to one or more other integrated PD modules 220p-q by the module controller 402 via the digital communication bus Comm. Accordingly, at step 1606, the amount of power P_{alloc}^{p} allocated to port p is updated to P_{sinkcap}. At step 1608, the USB-PD contract P_{contract}^{p} for port p is set to P_{alloc}^{p}. At step 1610, USB-PD contract negotiation for port p is initiated by the integrated PD module associated with port p, in accordance with the USB-PD standard. At step 1612, a Capability Mismatch flag for port p is cleared by the integrated PD module associated with port p. Flow of the process then returns to step 506 of FIG. 5.

FIG. 17 provides a portion of a simplified example process 1700 for adaptive power-sharing using the multi-port charger 201 shown in FIG. 2, in accordance with some embodiments. The particular step, the order in which the step is performed, and the combination of the step with other steps disclosed herein are shown for illustrative and explanatory purposes only. Other embodiments can implement different particular steps, orders of steps, and combinations of steps to achieve similar functions or results.

Step 1702 of the process 1700 continues from step 1214 shown in FIG. 12 and is conducted in response to determining by the integrated PD module associated with port p that a Capability Mismatch flag has been set for port p and that capability mismatch is unmasked for any port of the multi-port charger 201. In response, at step 1702, the integrated PD module associated with port p initiates a USB GetSinkCapabilities event for port p to receive P_{sinkcap} power for the sink device connected to port p, in accordance with the USB-PD standard.

FIGS. 18-20 illustrate embodiments in which each integrated power delivery module can provide more power than is typically available under normal thermal constraints, but for a short time period. This exception to normal thermal constraints takes advantage of the fact that the thermal time constant of the system (i.e., the multi-port charger) can result in it taking several seconds or even minutes for the system to heat up after an increase in power consumption by the attached sink device. This effect of the thermal time constant of the system can also be used to allocate a total power to all ports that have a sink device connected thereto. In this case, the total allocated power may be greater than the total power that the multi-port charger is either overall capable of providing or currently able to provide under current thermal conditions. Alternatively, the multi-port charger can allocate a power amount to an individual port (i.e., of one of the integrated power delivery modules) that is greater than the power that the port can normally provide under the same power draw conditions. Because a connected sink device sometimes does not use the total power amount that has been allocated to it, this technique can allow the multi-port charger to allocate more total power than the multi-port charger (or parts thereof) can sustainably provide for a limited time period based on the multi-port charger's rate of response to a change in temperature and a duration of time that the multi-port charger's steady state rated temperature/power capability (e.g., the specified maximum temperature threshold value) has been exceeded. For example, in some embodiments, the limited time period may be based on a thermal time constant of the multi-port charger (e.g., a multiple, such as 1 to 3 times the thermal time constant) or a time that is somewhat shorter than 1 to 3 thermal time constants such that the multi-port charger can adequately communicate with connected sink devices to gracefully bring the total power level down within the limited time period. At the end of this limited time period, the multi-port charger reduces the total system power and/or the power allocated to individual integrated power delivery modules if the steady state temperature/power capability has been exceeded for a set amount of time, e.g., the limited time period. The set amount of time can be programmable for different systems and can be variable. For example, the set amount of time can be longer for a smaller power delta/difference between the available power and the current instantaneous power being used and shorter for a larger delta, because a smaller power delta results in a slower temperature change and a larger power delta results in a faster temperature change.

Additionally, the allocated power to any of the integrated power delivery modules can be reduced without advertising the power reduction to the sink device connected to that integrated power delivery module in order to allocate more power to other integrated power delivery modules and respective connected sink devices. Upon the occurrence of an overcurrent event that lasts longer than another programmable amount of time for the integrated power delivery module with the reduced power allocation, the power allocation to other integrated power delivery modules can be reduced (or taken back) in order to increase the power allocation to the first integrated power delivery module (i.e., back to its original power allocation) without the first integrated power delivery module ever being notified that its power allocation had been temporarily reduced.

Alternatively or additionally, the integrated power delivery modules can sense or receive the temperature of the connected sink device or in a specific location (or locations) within the multi-port charger housing (e.g., on or adjacent to circuit boards therein, within the integrated PD modules of the multi-port charger, etc.). This temperature information is used to reduce the allocated power level to the multi-port charger or one or more of the integrated power delivery modules thereof when the measured temperature reaches a specified maximum temperature threshold value. When more power is produced than the multi-port charger and/or any of the integrated power delivery modules thereof has been allocated, then the temperature information can also be used alone or in combination with the measured power information, a measured duration of time that a temperature/power level has been exceed, and a threshold set amount of time to reduce the allocated power to the multi-port charger and/or any of the integrated power delivery modules thereof.

In addition to keeping the total power level for an extended amount of time below the specified maximum power threshold value level due to the thermal capabilities of a power conversion system, there may be other reasons for doing so, e.g., keeping the average power below a level at which country regulations would require power factor correction.

FIG. 18 provides a portion of a simplified example process 1800 for adaptive power-sharing by the multi-port charger 201 shown in FIG. 2, in accordance with some embodiments. The process 1800 enables the advantage of temporarily increasing the total power allocation to the integrated PD modules or the sink devices attached thereto to a level above the total rated power that the multi-port charger can sustainably produce when a temperature within the multi-port charger (i.e., the temperature of the multi-port charger 201 (or a part thereof) or one of the integrated PD modules (or a part thereof)) is less than the specified maximum temperature threshold value, so that some or all of the connected sink devices can receive a greater amount of power than would normally be available but for a limited time, thereby enabling greater performance or faster battery charging for the affected sink devices. The particular steps, the order in which the steps are performed, and the combination of the steps with other steps disclosed herein are shown for illustrative and explanatory purposes only. Other embodiments can implement different particular steps, orders of steps, and combinations of steps to achieve similar functions or results.

The process 1800 is performed when the determination at step 518 is positive or “yes”, i.e., the total power draw of all of the sink devices attached to the multi-port charger 201 is less than the total power that the multi-port charger 201 can potentially produce, one of the sink devices attached to the multi-port charger 201 is drawing less than the total power allocated to that sink device, or a power request has simply been received. In any of these situations, at 1802, the multi-port charger 201 determines whether it has received a power request from one or more of the sink devices (new or existing) at the corresponding port (i.e., the corresponding integrated PD module) for more power than the maximum available power P_{available} (i.e., the request for power would use more power than is currently available). If this determination is negative or “no”, then there is no need to continue to perform the process 1800, so it branches to 1812 to reset the power allocation (if needed) to the total allowable power (i.e., the total power capacity of the multi-port charger or a lower amount if so requested) for each integrated PD module and/or for the multi-port charger 201. The process 1800 then branches back to 506 in the process 500 of FIG. 5 for each integrated PD module of the multi-port charger 201 to wait for another event detection at the port that corresponds to that integrated PD module. On the other hand, if the determination at 1802 is positive or “yes”, then the process 1800 further determines (at 1804), if the request from the sink device were to be granted, whether the total power allocated is less than (alternatively less than or equal to) 1.5 times the total power capacity that the multi-port charger can sustainably deliver without exceeding device ratings or temperature requirements for more than a set amount of time (i.e., a threshold multiplier times the total power capacity). If the determination at 1804 is negative or “no”, then again there is no need, or it is inappropriate, to continue to perform the process 1800, so it branches to 1812 to reset the power allocation (if needed) to the total allowable power (i.e., the total power capacity of the multi-port charger or a lower amount if so requested) for each integrated PD module and/or for the multi-port charger 201. The process 1800 then branches back to 506 in the process 500 of FIG. 5. On the other hand, if the determination at 1804 is positive or “yes”, then the process 1800 further determines (at 1806) whether a temperature within the multi-port charger (i.e., the temperature of the multi-port charger 201 (or a part thereof) or one of the integrated PD modules (or a part thereof)) is less than (alternatively less than or equal to) the specified maximum temperature threshold value. If the determination at 1806 is negative or “no”, then again there is no need, or it is inappropriate, to continue to perform the process 1800, so it branches to 1812 to reset the power allocation (if needed) to the total allowable power (i.e., the total power capacity of the multi-port charger or a lower amount if so requested) for each integrated PD module and/or for the multi-port charger 201. The process 1800 then branches back to 506 in the process 500 of FIG. 5. On the other hand, if the determination at 1806 is positive or “yes”, then the process 1800 increases or provides (at 1808) the power allocation to one or more of the integrated PD modules (i.e., to the one or more sink devices attached thereto) in accordance with the received request(s). This increase of the power allocation results in the total allocated power of the multi-port charger being greater than the total rated power capacity that the multi-port charger can sustainably produce.

At 1810, the process 1800 determines whether either 1) the monitored/measured total system power currently being delivered or provided by the multi-port charger 201 (i.e., via the integrated PD modules) is greater than (alternatively greater than or equal to) the total rated power that the multi-port charger can sustainably produce for longer than a timeout time period, or 2) a temperature within the multi-port charger (i.e., the temperature of the multi-port charger 201 (or a part thereof) or one of the integrated PD modules (or a part thereof)) is greater than or equal to (alternatively greater than) the specified maximum temperature threshold value. If one of the conditions at 1810 is true, i.e., the determination at 1810 is positive or “yes”, then this indicates that the conditions that allow for the temporary increase of power allocation have ended, so the process 1800 resets (at 1812) the power allocation to the total allowable power (i.e., the total power capacity of the multi-port charger or a lower amount if so requested) for each integrated PD module and/or for the multi-port charger 201. After 1812, the process 1800 branches back to 506 in the process 500 of FIG. 5. On the other hand, if the determination at 1810 is negative or “no”, then the process 1800 waits for one of the conditions at 1810 to become true by looping (through 1814) back to 1810 to repeatedly monitor the total system power and/or the appropriate temperature measurement until after the timeout time period. While the process 1800 repeats the loop at 1810, the process also determines (at 1814) whether a sink device is attached to a port, removed or disconnected from a port, or requests a different or new power allocation (i.e., changes its power allocation request). In other words, step 1814 determines or detects whether a change in the power allocation has occurred or been requested, which renders the current allocation invalid or inappropriate. If the determination at 1814 is positive or “yes”, then the process 1800 proceeds to 1812 to reset the power allocation, so that the change in the power allocation is accounted for. Then the process 1800 branches back to 506 in the process 500 of FIG. 5. On the other hand, if the determination at 1814 is negative or “no”, then the process 1800 returns to 1810.

FIG. 19 provides a portion of an alternative simplified example process 1900 for adaptive power-sharing by the multi-port charger 201 shown in FIG. 2, in accordance with some embodiments. The process 1900 enables the advantage of temporarily increasing the total power allocation to the integrated PD modules or sink devices to a level above the total rated power that the multi-port charger can sustainably produce when 1) a temperature within the multi-port charger (i.e., the temperature of the multi-port charger 201 (or a part thereof) or one of the integrated PD modules (or a part thereof)) is less than the specified maximum temperature threshold value and 2) one of the sink devices attached thereto is not using its full power allocation, so that some or all of the connected sink devices can receive a greater amount of power than would normally be available but for a limited time, thereby enabling greater performance or faster battery charging for the sink devices that receive greater power. The multi-port charger 201 reduces the power allocation to the sink device that is not using its full power allocation but does not advertise this reduction to the sink device, so that the sink device will operate normally and can potentially return to using its full power allocation. The particular steps, the order in which the steps are performed, and the combination of the steps with other steps disclosed herein are shown for illustrative and explanatory purposes only. Other embodiments can implement different particular steps, orders of steps, and combinations of steps to achieve similar functions or results.

The process 1900 is an alternative to the process 1800. Thus, the process 1900 is performed when the determination at step 518 is positive or “yes”, i.e., the total power draw of all of the sink devices attached to the multi-port charger 201 is less than the total power that the multi-port charger 201 can potentially produce, or one of the sink devices attached to the multi-port charger 201 is drawing less than the total power allocated to that sink device. In this situation, at 1902, the multi-port charger 201 determines whether it has received a new request from one or more of the sink devices at the corresponding port for more power than the maximum available power P_{available}. If this determination is negative or “no”, then there is no need to continue to perform the process 1900, so it branches back to 506 in the process 500 of FIG. 5 for each integrated PD module of the multi-port charger 201 to wait for another event detection at the port that corresponds to that integrated PD module. On the other hand, if the determination at 1902 is positive or “yes”, then the process 1900 further determines (at 1904) whether the monitored/measured port/module power level provided to another port (i.e., an integrated PD module other than for the port corresponding to the sink device that requested power at 1902) has been lower than a power threshold value that (if the power were to be allocated to that other port at the same level as the monitored module level) would lower the total allocated power enough for it to be possible to grant the new request (for at least a programmable time amount or threshold time period). (In this situation, the monitored/measured module power level is less than a current allocated power level for that integrated PD module, so it might be possible to reduce the allocated power level to the monitored/measured module power level for the time period without adversely affecting the sink device attached thereto. Additionally, the sum of the lowered total allocated power and the power level of the new request would be less than or equal to the threshold multiplier times the total rated power that the multi-port charger can sustainably produce, so the new request could be granted for the time period.) If the determination at 1904 is negative or “no”, then again there is no need, or it is inappropriate, to continue to perform the process 1900, so it branches back to 506 in the process 500 of FIG. 5. On the other hand, if the determination at 1904 is positive or “yes”, then the process 1900 further determines (at 1906) whether a temperature within the multi-port charger (i.e., the temperature of the multi-port charger 201 (or a part thereof) or one of the integrated PD modules (or a part thereof)) is less than (alternatively less than or equal to) the specified maximum temperature threshold value. If the determination at 1906 is negative or “no”, then it would be inappropriate to continue to perform the process 1900, so it branches back to 506 in the process 500 of FIG. 5. On the other hand, if the determination at 1906 is positive or “yes”, then the process 1900 decreases (at 1908) the power allocation to the integrated PD module for the port that is using the lower power level to the monitored/measured module power level. However, the multi-port charger 201 does not advertise to that integrated PD module that it is receiving a lower power allocation, so that the sink device attached thereto continues to operate normally (or as it did previously) and not potentially go into a lower power mode with a reduced performance. Additionally, the process 1900 increases the power allocation to one or more of the other integrated PD modules in accordance with the received request(s), e.g., this increases the allocated power level for the integrated PD module to which the sink device that made the request is attached. Furthermore, by not advertising the lower power allocation to the integrated PD module for the port that is using the lower power level, the multi-port charger 201 can monitor the power usage of the respective sink device for a condition in which the sink device exceeds its lower power allocation (e.g., for a programmable amount of time), and then the multi-port charger 201 can increase the power allocation for that sink device (and optionally reduce the power allocation for other integrated PD modules as needed to meet the total system requirements).

At 1910, the process 1900 determines whether either 1) the monitored/measured total system power level currently being delivered by the multi-port charger 201 has been greater than (alternatively greater than or equal to) the total rated power that the multi-port charger can sustainably produce for longer than a timeout time period or 2) a temperature within the multi-port charger (i.e., the temperature of the multi-port charger 201 (or a part thereof) or one of the integrated PD modules (or a part thereof)) is greater than or equal to (alternatively greater than) the specified maximum temperature threshold value (e.g., for a predetermined amount of time. If one of the conditions at 1910 is true, i.e., the determination at 1910 is positive or “yes”, then this indicates that the conditions that allow for the temporary increase of power allocation to some of the integrated PD modules have ended, so the process 1900 resets (at 1912) the power allocation to the total allowable (or a lower amount if so requested) for each integrated PD module and/or for the multi-port charger 201. After 1912, the process 1900 branches back to 506 in the process 500 of FIG. 5. On the other hand, if the determination at 1910 is negative or “no”, then the process 1900 waits for one of the conditions at 1910 to become true by looping (through 1914) back to 1910 to repeatedly monitor the total system power and/or the appropriate temperature measurement. While the process 1900 repeats the loop at 1910, the process also determines (at 1914) whether a sink device is attached to a port, removed from a port, or requests a different power allocation. In other words, step 1914 determines or detects whether a change in the power allocation has occurred or been requested, which renders the current allocation invalid or inappropriate. If the determination at 1914 is positive or “yes”, then the process 1900 proceeds to 1912 to reset the power allocation, so that the change in the power allocation is accounted for. Then the process 1900 branches back to 506 in the process 500 of FIG. 5. On the other hand, if the determination at 1914 is negative or “no”, then the process 1900 returns to 1910.

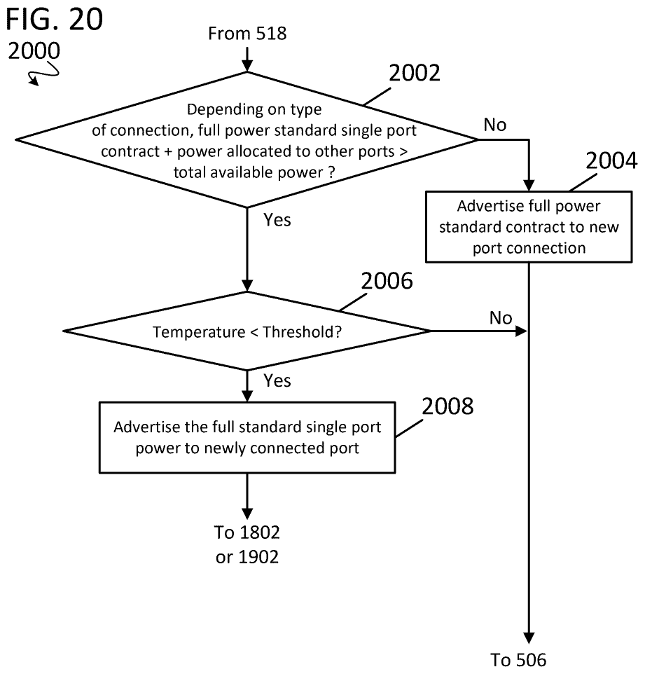

FIG. 20 provides an additional simplified example process 2000 which may optionally be performed before either process 1800 or 1900 upon branching from step 518 or which may be considered an initial portion of either process 1800 or 1900, in accordance with some embodiments. The particular steps, the order in which the steps are performed, and the combination of the steps with other steps disclosed herein are shown for illustrative and explanatory purposes only. Other embodiments can implement different particular steps, orders of steps, and combinations of steps to achieve similar functions or results.

The process 2000 is performed when the determination at step 518 is positive or “yes”, i.e., the total power draw of all of the sink devices attached to the multi-port charger 201 is less than the total power that the multi-port charger 201 can potentially produce, or one of the sink devices attached to the multi-port charger 201 is drawing less than the total power allocated to that sink device. In this situation, at 2002, the multi-port charger 201 (depending on the type of new connection made to the port of the integrated PD module) determines whether a sum of a full power standard single port contract (i.e., a full power allocation) for satisfying the request for power and all of the power already or currently allocated to other ports is greater than the total rated power that the multi-port charger can sustainably produce. If the determination at 2002 is negative or “no”, then the multi-port charger 201 instructs (at 2004) the integrated PD module to advertise a full power standard contract (i.e., sends a notification of a full power allocation) to the sink device that caused the new port connection, because there is no need to reduce the power to any of the integrated PD modules in this situation. Then the process 2000 branches back to 506 in the process 500 of FIG. 5. On the other hand, If the determination at 2002 is positive or “yes”, then the process 2000 determines (at 2006) whether a temperature within the multi-port charger (i.e., the temperature of the multi-port charger 201 (or a part thereof) or one of the integrated PD modules (or a part thereof)) is less than (alternatively less than or equal to) the specified maximum temperature threshold value. If the determination at 2006 is negative or “no”, then there is no need to reduce the power to any of the integrated PD modules in this situation, so the process 2000 branches back to 506 in the process 500 of FIG. 5. On the other hand, If the determination at 2006 is positive or “yes”, then the multi-port charger 201 instructs (at 2008) the integrated PD module to advertise the full power standard single port contract (i.e., sends a notification of a full power allocation) to the sink device that caused the new port connection. The process 2000 then branches to either process 1800 or 1900, depending on which is used in the embodiment. In this manner, the newly connected sink device starts with a full power allocation before the multi-port charger 201 begins cither process 1800 or 1900.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method performed by a multi-port charger, comprising:
allocating a total allocated power to power delivery modules of the multi-port charger for the power delivery modules to provide power to respective sink devices attached thereto at less than or equal to a total rated power capacity of the multi-port charger;
receiving a request for power from a sink device of the sink devices;
determining when the request for power is for more power than is currently available;
determining when, if the request for power were to be granted, the total allocated power of the multi-port charger would be less than the total rated power capacity of the multi-port charger times a threshold multiplier;
determining when a temperature within the multi-port charger is less than a maximum temperature threshold value;
providing a power allocation to the sink device resulting in the total allocated power of the multi-port charger being greater than the total rated power capacity of the multi-port charger; and
after the total allocated power has been higher than the total rated power capacity for longer than a timeout time period, resetting the total allocated power to be less than or equal to the total rated power capacity of the multi-port charger.

2. The method of claim 1, wherein before determining that the request for power is for more power than is currently available, the method further comprises:
determining when a sum of a full power standard single port contract for satisfying the request for power and all power currently allocated to other ports is greater than the total rated power capacity of the multi-port charger;
determining when the temperature within the multi-port charger is less than the maximum temperature threshold value; and
advertising the full power standard single port contract to the sink device.

3. The method of claim 1, wherein:
the threshold multiplier is about 1.5.

4. The method of claim 1, wherein:
the resetting of the total allocated power is also performed when the temperature within the multi-port charger is greater than the maximum temperature threshold value.

5. The method of claim 1, wherein:
the resetting of the total allocated power is also performed when one of the sink devices is attached to or disconnected from one of the power delivery modules or changes its power allocation request.

6. The method of claim 1, wherein:
during the timeout time period, a total measured power being provided by the power delivery modules is greater than the total rated power capacity of the multi-port charger.

7. A method performed by a multi-port charger, comprising:
allocating a total allocated power to power delivery modules of the multi-port charger for the power delivery modules to provide power to respective sink devices attached thereto at less than or equal to a total rated power capacity of the multi-port charger;
receiving a request for power from a sink device of the sink devices at a first power delivery module of the power delivery modules;
determining when the request for power is for more power than is currently available;
determining when a monitored module power level provided to a second power delivery module has been lower than a power threshold value for at least a threshold time period, wherein the monitored module power level is less than an allocated power level for the second power delivery module;
reducing the allocated power level for the second power delivery module to the monitored module power level without advertising a reduced allocated power level to the second power delivery module;
increasing an allocated power level for the first power delivery module in accordance with the request for power from the sink device; and
after the total allocated power has been higher than the total rated power capacity for longer than a timeout time period, resetting the total allocated power to be less than or equal to the total rated power capacity of the multi-port charger.

8. The method of claim 7, wherein before determining that the request for power is for more power than is currently available, the method further comprises:
determining when a sum of a full power standard single port contract for satisfying the request for power and all power currently allocated to other ports is greater than the total rated power capacity of the multi-port charger;
determining when a temperature within the multi-port charger is less than a maximum temperature threshold value; and
advertising the full power standard single port contract to the sink device.

9. The method of claim 7, wherein:
the increasing of the allocated power level for the first power delivery module results in the total allocated power of the multi-port charger being greater than the total rated power capacity of the multi-port charger.

10. The method of claim 9, wherein:
the increasing of the allocated power level for the first power delivery module results in the total allocated power of the multi-port charger being less than the total rated power capacity of the multi-port charger times a threshold multiplier.

11. The method of claim 10, wherein:
the threshold multiplier is about 1.5.

12. The method of claim 7, wherein:
the resetting of the total allocated power is also performed when a temperature within the multi-port charger is greater than a maximum temperature threshold value.

13. The method of claim 7, wherein:
the resetting of the total allocated power is also performed when one of the sink devices is attached to or disconnected from one of the power delivery modules or changes its power allocation request.

14. The method of claim 7, wherein:
during the timeout time period, a total measured power being provided by the power delivery modules is greater than the total rated power capacity of the multi-port charger.

15. A multi-port charger, comprising:
power delivery modules to which has been allocated a total allocated power for the power delivery modules to provide power to respective sink devices attached thereto at less than or equal to a total rated power capacity of the multi-port charger;
wherein:
when a sink device of the sink devices at a first power delivery module of the power delivery modules requires power, a request for power is generated;
when 1) the request for power is for more power than is currently available, and 2) a monitored module power level provided to a second power delivery module has been lower than a power threshold value for at least a threshold time period, wherein the monitored module power level is less than an allocated power level for the second power delivery module, then the allocated power level for the second power delivery module is reduced to the monitored module power level without advertising a reduced allocated power level to the second power delivery module, and an allocated power level for the first power delivery module is increased in accordance with the request for power from the sink device; and
after the total allocated power has been higher than the total rated power capacity for longer than a timeout time period, the total allocated power is reset to be less than or equal to the total rated power capacity of the multi-port charger.

16. The multi-port charger of claim 15, wherein:
before a determination that the request for power is for more power than is currently available, when 1) a sum of a full power standard single port contract for satisfying the request for power and all power currently allocated to other ports is greater than the total rated power capacity of the multi-port charger, and 2) a temperature within the multi-port charger is less than a maximum temperature threshold value, then the full power standard single port contract is advertised to the sink device.

17. The multi-port charger of claim 15, wherein:
the increase of the allocated power level for the first power delivery module results in the total allocated power of the multi-port charger being greater than the total rated power capacity of the multi-port charger.

18. The multi-port charger of claim 17, wherein:
the increase of the allocated power level for the first power delivery module results in the total allocated power of the multi-port charger being less than the total rated power capacity of the multi-port charger times a threshold multiplier.

19. The multi-port charger of claim 15, wherein:
the reset of the total allocated power is also performed when a temperature within the multi-port charger is greater than a maximum temperature threshold value for a predetermined amount of time.

20. The multi-port charger of claim 15, wherein:
during the timeout time period, a total measured power being provided by the power delivery modules is greater than the total rated power capacity of the multi-port charger.
